(19) United States
(12) Patent Application Publication
(10) Pub. No.: US 2023/0224195 A1
(43) Pub. Date: Jul. 13, 2023

(54) MODULATION MODULE, MODULATION CIRCUIT, MODULATION DEVICE, AND GENERATION METHOD FOR MODULATION SIGNAL

(71) Applicant: LAPIS Technology Co., Ltd., Yokohama (JP)

(72) Inventor: Masato YAMAZAKI, Yokohama (JP)

(73) Assignee: LAPIS Technology Co., Ltd., Yokohama (JP)

(21) Appl. No.: 18/153,793

(22) Filed: Jan. 12, 2023

(30) Foreign Application Priority Data
Jan. 13, 2022 (JP) 2022-003691
Sep. 12, 2022 (JP) 2022-144324

(51) Int. Cl. H04L 27/00

(52) U.S. Cl. CPC H04L 27/0008; H04L 27/0012

(57) ABSTRACT

A modulation module includes a first modulation circuit that, upon receiving input of first setting information including first information designating a modulation mode, outputs a prescribed auxiliary signal as a first output signal, but upon receiving input of second setting information including second information designating a different modulation mode from the first information, outputs a first modulation signal generated by subjecting an input signal to modulation processing based on the second setting information as the first output signal. The modulation module further includes a second modulation circuit that is configured to output, as a second output signal, a signal generated by combining a second modulation signal generated by modulation processing and the first output signal.

### CROSS REFERENCE TO RELATED APPLICATION

This application is based upon and claims the benefit of priority of the prior Japanese Patent Application No. 2022-144324, filed on Sep. 12, 2022, and the prior Japanese Patent Application No. 2022-003691, filed on Jan. 13, 2022, the entire contents of which are incorporated herein by reference.

### TECHNICAL FIELD

The present invention relates to a modulation module, a modulation circuit, a modulation device, and a generation method for a modulation signal by which modulation based on setting information is performed on a carrier wave.

### BACKGROUND ART

Communication devices are equipped with a modulator that modulates a carrier wave according to a modulation method suited to the state of a transmission path or the quantity of transmitted data.

Also, in recent years, a communication device has been proposed in which the modulation method can be switched by providing two modulation circuits, each of which handles a different modulation mode, and enabling a user to select the desired modulation circuit among the two modulation circuits (e.g., see Japanese Patent No. 4579007).

The communication device disclosed in Japanese Patent No. 4579007 includes a first modulation circuit that performs ASK (amplitude-shift keying) modulation on a transmission data signal and a second modulation circuit that performs modulation of a mode differing from ASK modulation on the transmission data signal. Additionally, the communication device includes a selection unit that selects either one of a first or second high frequency signal outputted from the first and second modulation circuits, and an orthogonal modulation unit that generates a modulation signal for transmission by performing orthogonal modulation based on the selected high frequency signal.

### SUMMARY OF THE INVENTION

However, the communication device disclosed in Japanese Patent No. 4579007 has the problem that a specialized modulation circuit that performs modulation processing according to modulation modes is necessary for each modulation mode, and thus, the device size increases in proportion to the number of modulation modes between which switching is enabled.

An object of the present invention is to provide a modulation module, a modulation circuit, a modulation device, and a generation method for a modulation signal that are compatible with a plurality of modulation modes while mitigating an increase in device size.

A representative example of a modulation module according to the present invention includes: a first modulation circuit that, upon receiving input of first setting information including first information designating a modulation mode, outputs a prescribed auxiliary signal as a first output signal, but upon receiving input of second setting information including second information designating a different modulation mode from the first information, outputs a first modulation signal generated by subjecting an input signal to modulation processing based on the second setting information as the first output signal; and a second modulation circuit that is configured to output, as a second output signal, a signal generated by combining a second modulation signal generated by modulation processing with the first output signal.

The modulation module according to the present invention is compatible with a plurality of modulation modes while an increase in device size is mitigated.

### BRIEF DESCRIPTION OF THE DRAWINGS

FIG. 1 is a block diagram showing the configuration of a modulation module 200 as a modulation device according to Embodiment 1.

FIG. 2 shows operation aspects of modulation circuits 21 and 22 set by a modulation mode signal MOD and individual setting signals X1 and X2.

FIG. 3 is a block diagram showing the internal configuration of the modulation circuits 21 and 22.

FIG. 4A shows conversion tables A and Aq of a sine wave generation circuit 14.

FIG. 4B shows a conversion table B of the sine wave generation circuit 14.

FIG. 5 shows an internal operational aspect of each of the modulation circuits 21 and 22 during QPSK mode.

FIG. 6 shows an internal operational aspect of each of the modulation circuits 21 and 22 during ASK mode.

FIG. 7 shows an internal operational aspect of each of the modulation circuits 21 and 22 during FSK mode.

FIG. 8 shows an internal operational aspect of each of the modulation circuits 21 and 22 during 16 QAM mode.

FIG. 9 is a circuit diagram showing an example of an internal configuration of a combination circuit 13.

FIG. 10 is a diagram showing an example of a truth table of a decoder 130.

FIG. 11 is a circuit diagram showing an example of an internal configuration of a combination circuit 15.

FIG. 12 is a block diagram showing the configuration of a modulation device 300 according to Embodiment 2.

FIG. 13 is a block diagram showing the configuration of a modulation device 400 according to Embodiment 3.

### DETAILED DESCRIPTION OF EMBODIMENTS

Embodiments of the present invention will be explained in detail below with reference to the drawings.

### Embodiment 1

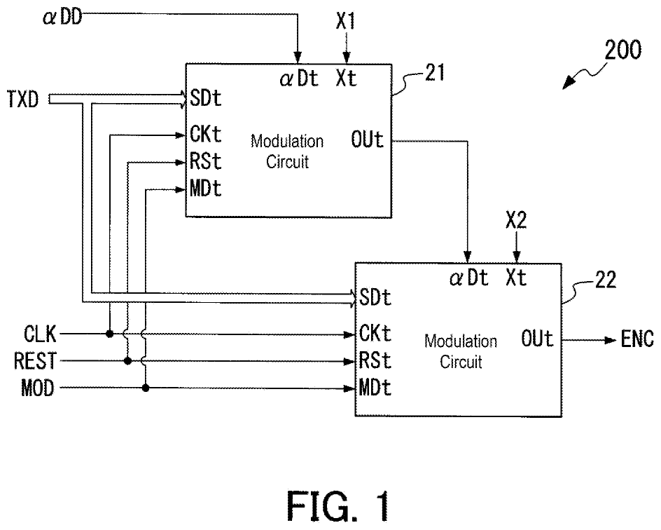

FIG. 1 is a block diagram showing the configuration of a modulation module 200 as a modulation module according to Embodiment 1.

The modulation module 200 is a multi-modulation mode-compatible modulation module that can modulate a carrier wave according to a designated modulation mode among a plurality of modulation modes including ASK, (amplitude-shift keying), FSK (frequency-shift keying), QPSK (quadrature phase-shift keying), and 16 QAM (quadrature amplitude modulation), for example.

The modulation module 200 is formed on a single semiconductor IC chip, for example, and includes modulation circuits 21 and 22 that are connected in the manner shown in FIG. 1. The modulation circuits 21 and 22 each have a transmission data input terminal SDt, a clock input terminal CKt, a modulation mode input terminal MDt, an operation setting terminal Xt, an additional data input terminal αDt, a reset input terminal RSt, and an output terminal OUt.

Each of the modulation circuits 21 and 22 is configured to receive a clock signal CLK corresponding to the carrier wave frequency at the clock input terminal CKt, and to receive a reset signal REST prompting initialization at the reset input terminal RSt.

Additionally, each of the modulation circuits 21 and 22 is configured to receive, at the modulation mode input terminal MDt, a modulation mode signal MOD designating any one of ASK mode, in which the carrier wave is subjected to amplitude modulation, FSK mode, in which the carrier wave is subjected to frequency modulation, QPSK mode, in which the carrier wave is subjected to phase modulation, 16 QAM mode, in which the carrier wave is subjected to phase-amplitude modulation, a combined modulation mode that combines a plurality of the modulation modes, or the like. Here, the modulation mode signals designating FSK mode and QPSK mode are examples of first information designating the modulation mode, and the modulation mode signals designating ASK mode and 16 QAM mode are examples of second information designating the modulation mode.

The modulation circuit 21 receives a transmission data signal TXD representing information data to be transmitted at the transmission data input terminal SDt, and receives an additional data signal αDD at the additional data input terminal αDt. Additionally, the modulation circuit 21 receives, at the operation setting terminal Xt, an individual setting signal X1 at a logic level of 0 or 1, for example, for setting the operation of the modulation circuit 21. The output terminal OUt of the modulation circuit 21 is connected to the additional data input terminal αDt of the modulation circuit 22. As will be described in detail below, output signals differing for each modulation mode are inputted to the additional data input terminal αDt of the modulation circuit 22 via the output terminal OUt of the modulation circuit 21. Here, the modulation mode signal MOD and the individual setting signal X1 are examples of setting information.

The modulation circuit 22 sets the operation thereof as well as receiving the transmission data signal TXD at the transmission data input terminal SDt. An individual setting signal X2 at a logic level of 0 or 1, for example, is received at the operation setting terminal Xt. The modulation circuit 22 outputs, from the output terminal OUt, a modulation signal ENC formed by modulating a carrier wave on the basis of the transmission data signal TXD in the modulation mode designated by the modulation mode signal MOD. Here, the modulation mode signal MOD and the individual setting signal X2 are examples of setting information. In this case, the modulation circuits 21 and 22 may have the same circuit configuration, in which case, the modulation circuits perform differing operations from each other by causing the individual setting signals X1 and X2 to differ from each other.

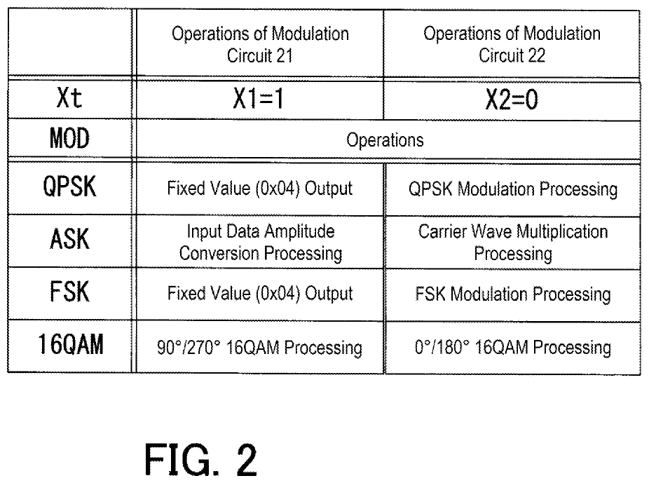

Operations of the modulation circuit 21 and 22 of FIG.1 will be explained with reference to FIG. 2. FIG. 2 is a table showing operation aspects of modulation circuits 21 and 22 set by a modulation mode signal MOD and individual setting signals X1 and X2. The row of Xt shows the logic levels for the individual setting signals X1 and X2, which are respectively supplied to the modulation circuits 21 and 22. The columns below MOD show the respective operation aspects of the modulation circuits 21 and 22 for each modulation mode.

If the same circuit configuration is used for the modulation circuits 21 and 22, the individual setting signal X1 having a logic level of 1 is supplied to the modulation circuit 21 and the individual setting signal X2 having a logic level of 0 is supplied to the modulation circuit 22. Here, if the modulation module 200 is set to operate as a QPSK modulation circuit, then the modulation mode signal MOD designating QPSK mode is supplied to the modulation circuits 21 and 22. If the modulation module 200 is set to operate as an ASK modulation circuit, then the modulation mode signal MOD designating ASK mode is supplied to the modulation circuits 21 and 22. If the modulation module 200 is set to operate as an FSK modulation circuit, then the modulation mode signal MOD designating FSK mode is supplied to the modulation circuits 21 and 22. If the modulation module 200 is set to operate as a 16 QAM modulation circuit, then the modulation mode signal MOD designating 16QAM mode is supplied to the modulation circuits 21 and 22.

As a result, during QPSK mode, the modulation circuit 21 is set to a state of outputting 0x04, which is an 8-bit fixed value, and the modulation circuit 22 is set to a state of performing QPSK modulation processing. During ASK mode, the modulation circuit 21 is set to a state of performing amplitude modulation processing of input data, and the modulation circuit 22 is set to a state of performing carrier wave multiplication processing. During FSK mode, the modulation circuit 21 is set to a state of outputting 0x04, which is an 8-bit fixed value, and the modulation circuit 22 is set to a state of performing FSK modulation processing. During 16 QAM mode, the modulation circuit 21 is set to a state of performing 90°/270° 16 QAM processing, and the modulation circuit 22 is set to a state of performing 0°/180° 16 QAM processing. Here, the 90°/270° 16 QAM processing and the 0°/180° 16 QAM processing are examples of phase/amplitude modulation processing.

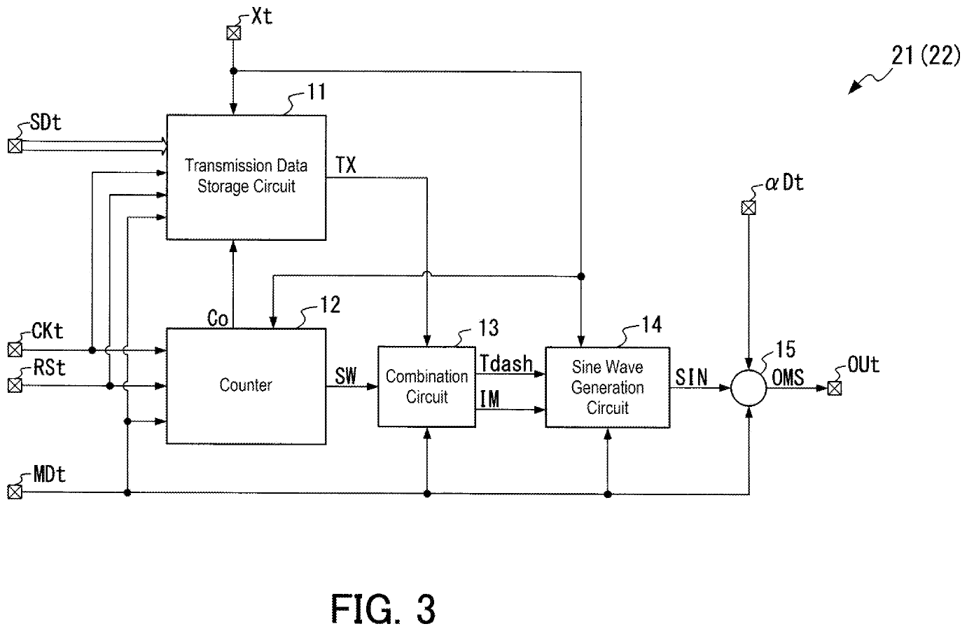

FIG. 3 is a block diagram showing the internal configuration of the modulation circuits 21 and 22 for when the same circuit configuration is used for both thereof.

As shown in FIG. 3, the modulation circuits 21 and 22 have a transmission data storage circuit 11, a counter 12, combination circuits 13 and 15, and a sine wave generation circuit 14. The transmission data storage circuit 11, the counter 12, the combination circuit 13, and a sine wave generation circuit 14 are examples of main processing units.

As shown in FIG. 3, in the modulation circuit 21 (22), the transmission data input terminal SDt is connected to the transmission data storage circuit 11, and the clock input terminal CKt and the reset input terminal RSt are connected to the transmission data storage circuit 11 and the counter 12. Also, in the modulation circuit 21 (22), the modulation mode input terminal MDt is connected to the transmission data storage circuit 11, the counter 12, the combination circuits 13 and 15, and the sine wave generation circuit 14, and the operation setting terminal Xt is connected to the transmission data storage circuit 11, the counter 12, and the sine wave generation circuit 14. Additionally, in the modulation circuit 21 (22) the additional data input terminal αDt is connected to the combination circuit 15.

Upon receiving a signal with a logic level of 0 or 1 via the operation setting terminal Xt and the modulation mode signal MOD designating the modulation mode via the modulation mode input terminal MDt, the transmission data storage circuit 11 converts the transmission data signal TXD received via the transmission data input terminal SDt into prescribed data pieces and stores the same. The transmission data storage circuit 11 then outputs a data signal TX including the stored prescribed data pieces. However, if the modulation mode signal MOD designating QPSK mode is received and a signal at a logic level of 1 is received via the operation setting terminal Xt, or if the modulation mode signal MOD designating FSK mode is received and a signal at a logic level of 1 is received via the operation setting terminal Xt, then the transmission data storage circuit 11 enters an operation stoppage state where the above-mentioned operation is not performed.

The transmission data storage circuit 11 initializes all stored content to zero, for example, according to the reset signal REST received via the reset input terminal RSt regardless of the modulation mode signal MOD designating the modulation mode.

The counter 12 is a 4-bit hexadecimal counter, for example, that receives via the clock input terminal CKt the clock signal CLK having a frequency corresponding to the carrier wave frequency, and increments the pulse count of the clock signal CLK. The counter 12 increases the count value by one at a time for each pulse of the clock signal CLK, starting from the initial count value of zero (0b0000), and upon reaching the maximum count value of 15 (0b1111), outputs and stores a carry out signal Co in the transmission data storage circuit 11. The counter 12 then repeats the operation of restoring the count value to zero according to the next pulse of the clock signal CLK and then continually increasing the count value one at a time for every pulse of the clock signal CLK. Thus, the sequence of the count values attained by the count operation has a sawtooth waveform.

During this time, when the counter 12 receives a signal with a logic level of 0 via the operation setting terminal Xt, the counter 12 outputs the sequence of the count values as a signal SW representing a sawtooth waveform, and supplies the signal SW to the combination circuit 13. On the other hand, if the counter 12 receives a signal with a logic level of 1 via the operation setting terminal Xt, the counter 12 performs the above-mentioned count operation (including output of the carry out signal Co), but supplies to the combination circuit 13 a signal SW representing zero (0b0000) regardless of the count value. However, when the counter 12 receives the modulation mode signal MOD designating the 16 QAM mode, the counter 12 outputs the sequence of the count values as a signal SW representing a sawtooth waveform, and supplies the signal SW to the combination circuit 13, regardless of the logic level of the signal received via the operation setting terminal Xt. Here, the signal SW can be said to be a frequency signal.

The counter 12 initializes the count value to zero (0b0000) according to the reset signal REST received via the reset input terminal RSt.

The combination circuit 13 is a circuit that combines the data signal TX supplied from the transmission data storage circuit 11 with the signal SW supplied from the counter 12. The combination circuit 13 operates as an adder when receiving the modulation mode signal MOD designating QPSK mode, ASK mode, or 16 QAM via the modulation mode input terminal MDt, and operates as a multiplier when receiving the modulation mode signal MOD designating FSK mode via the modulation mode input terminal MDt. The addition results by the adder and the multiplication results by the multiplier are generated as a signal IM represented in 4 bits, for example, and are supplied to the sine wave generation circuit 14. Additionally, if the combination circuit 13 is receiving a modulation mode signal MOD designating the 16 QAM mode via the modulation mode input terminal MDt, the combination circuit 13 generates a 1-bit signal Tdash representing the logic level of the least significant bit of the data signal TX along with the signal IM, and supplies the foregoing to the sine wave generation circuit 14.

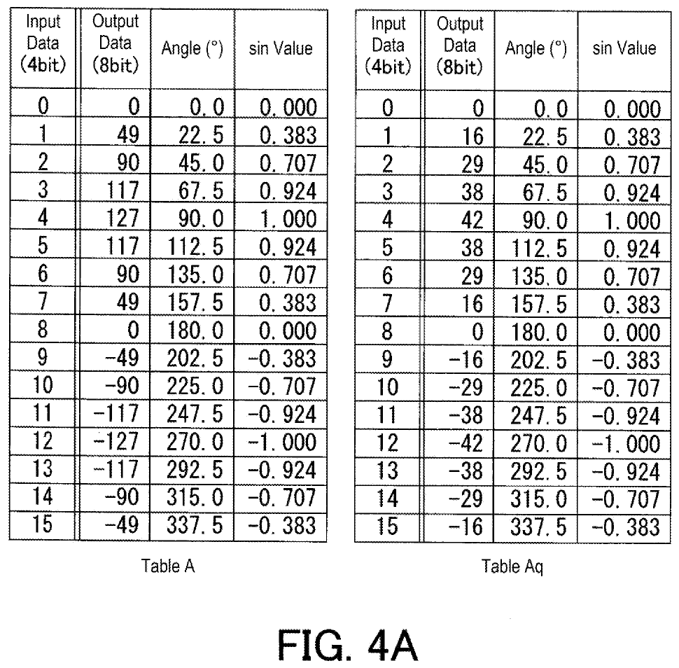

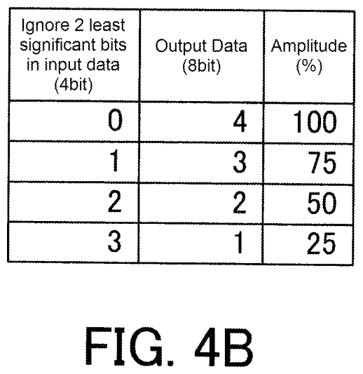

The sine wave generation circuit 14 converts the sequence of data pieces represented by the signal IM into a signal SIN representing a sine wave of a sequence of 8-bit data pieces, for example. The sine wave generation circuit 14 has conversion tables A and Aq shown in FIG. 4A and a conversion table B shown in FIG. 4B, and converts the sequence of data pieces of the signal IM to the signal SIN according to the conversion tables A, Aq, and B.

At this time, when the sine wave generation circuit 14 receives a signal with a logic level of 0 via the operation setting terminal Xt, the sine wave generation circuit 14 converts the signal IM to the signal SIN according to the conversion table A shown in FIG. 4A and supplies the signal SIN to the combination circuit 15.

Also, when the sine wave generation circuit 14 receives the modulation mode signal MOD designating ASK mode via the modulation mode input terminal MDt and receives a signal with a logic level of 1 via the operation setting terminal Xt, the sine wave generation circuit 14 converts the signal IM to the signal SIN according to the conversion table B shown in FIG. 4B and supplies the signal SIN to the combination circuit 15.

Additionally, when the sine wave generation circuit 14 receives the modulation mode signal MOD designating QPSK mode or FSK mode and receives a signal with a logic level of 1 via the operation setting terminal Xt, the sine wave generation circuit 14 supplies the 8-bit signal SIN representing 0x04, for example, as a fixed value to the combination circuit 15 regardless of the content of the signal IM.

Also, when the sine wave generation circuit 14 receives the modulation mode signal MOD designating 16 QAM mode and the signal Tdash representing the logic level 0, the sine wave generation circuit 14 converts the signal IM to the signal SIN according to the conversion table A shown in FIG. 4A and supplies the signal SIN to the combination circuit 15. When the sine wave generation circuit 14 receives the modulation mode signal MOD designating the 16 QAM mode and the signal Tdash representing a logic level of 1, the sine wave generation circuit 14 converts the signal IM to the signal SIN according to the conversion table Aq shown in FIG. 4A and supplies the signal SIN to the combination circuit 15.

The combination circuit 15 is a circuit that combines the signal SIN supplied from the sine wave generation circuit 14 with the signal received via the additional data input terminal αDt. The combination circuit 15 of the modulation circuit 21 combines the signal SIN with the additional data signal αDD received via the additional data input terminal αDt. The additional data signal αDD is an external signal supplied from outside the modulation circuit 21, for example. The combination circuit 15 of the modulation circuit 22 combines the signal SIN with the output signal OMS outputted from the output terminal OUt of the modulation circuit 21. If the modulation mode signal MOD designating any one of QPSK mode, ASK mode, and FSK mode is received via the modulation mode input terminal MDt or the modulation mode signal MOD designating 16 QAM mode is received and a signal with a logic level of 1 is received via the operation setting terminal Xt, the combination circuit 15 operates as a multiplier. In this case, the combination circuit 15 outputs the multiplication results, from multiplying the signal received via the additional data input terminal αDt by the signal SIN, from the output terminal OUt as the output signal OMS. If the combination circuit 15 receives the modulation mode signal MOD designating the 16 QAM mode and receives a signal with a logic level of 0 via the operation setting terminal Xt, the combination circuit 15 operates as an adder and outputs the addition results, from adding the signal received via the additional data input terminal αDt to the signal SIN, from the output terminal OUt as the output signal OMS.

In this manner, the modulation circuits 21 and 22 include the combination circuit 13 and the combination circuit 15. The combination circuit 13 outputs a signal resulting from combining input signals on the basis of setting information including information designating the modulation mode. The combination circuit 15 outputs, as an output signal, a signal generated by combining a signal based on the signal outputted from the combination circuit 13 with an external signal inputted from outside, on the basis of the setting information.

Below, the internal operations of the modulation module 200 shown in FIG. 1, which has the modulation circuits 21 and 22 with the configuration shown in FIG. 3, will be described for each modulation mode including QPSK mode, ASK mode, FSK mode, and 16 QAM mode.

[QPSK Mode]

As previously described, in order to cause the modulation module 200 to operate in QPSK mode, the modulation mode signal MOD designating QPSK mode is supplied to the modulation circuits 21 and 22 as shown in FIG. 2. Also, the individual setting signal X1 having a logic level of 1 is supplied to the modulation circuit 21 and the individual setting signal X2 having a logic level of 0 is supplied to the modulation circuit 22.

Additionally, the clock signal CLK having a frequency corresponding to the carrier wave frequency is supplied to the modulation circuits 21 and 22, and the additional data signal αDD representing 4 as a decimal value is supplied to the modulation circuit 21.

As a result, the modulation module 200 is set to a QPSK mode operation state.

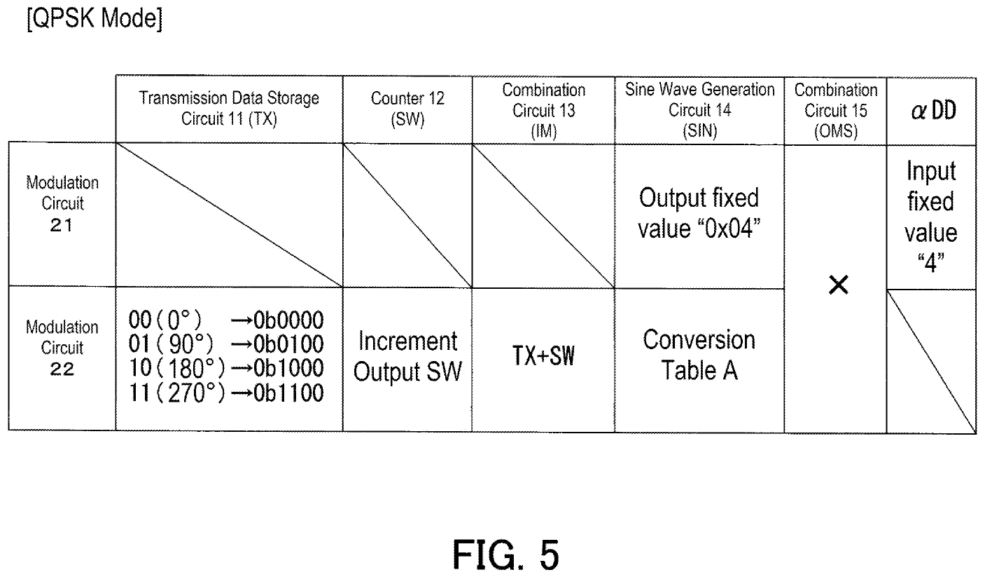

FIG. 5 shows the operational state of the transmission data storage circuit 11, the counter 12, the combination circuits 13 and 15, and the sine wave generation circuit 14 of each of the modulation circuits 21 and 22 during QPSK mode.

In QPSK mode, as shown in FIG. 5, the transmission data storage circuit 11 of the modulation circuit 22 receives and stores the transmission data signal TXD including a sequence of 00, 01, 10, and 11 as 2-bit data pieces representing 0°, 90°, 180°, and 270°, respectively, as shift angles. During this time, the transmission data storage circuit 11 reads the 2-bit data pieces in the order of being stored every time the carry out signal Co is supplied from the counter 12.

The transmission data storage circuit 11 of the modulation circuit 22 then converts the read out 2-bit data pieces to 4-bit data pieces as shown in FIG. 5.

That is, in QPSK mode, as shown in FIG. 5, the transmission data storage circuit 11 of the modulation circuit 22 converts each of the 2-bit data pieces to 4-bit data pieces representing 0, 4, 8, or 12 (all decimal values) according to the following correspondence relationships, and supplies the data signal TX constituted of the sequence of 4-bit data pieces to the combination circuit 13.

00 (0°)→0b0000

01 (90°)→0b0100

10 (180°)→0b0100

11 (270°)→0b1100

In QPSK mode, the counter 12 of the modulation circuit 22 repeats the operation of incrementing the pulse count of the clock signal CLK corresponding to the carrier wave frequency from the initial count value of zero, and restoring the count value to the initial value of zero upon reaching the maximum count value of 15. As a result, the counter 12 generates the signal SW including the sequence of count values forming a sawtooth waveform, and supplies the signal SW to the combination circuit 13.

That is, each period of the signal SW generated by the counter 12 corresponds to 16 count values from 0 to 15. Thus, 0 is added in order to perform a phase shift of 0° on the signal SW, 4 is added in order to perform a phase shift of 90°, 8 is added in order to perform a phase shift of 180°, and 12 is added in order to perform a phase shift of 270°.

In QPSK mode, the combination circuit 13 of the modulation circuit 22 operates as an adder. Every time a 4-bit data piece is outputted from the transmission data storage circuit 11, the combination circuit 13 supplies, as the signal IM to the sine wave generation circuit 14, a sequence of 16 4-bit data pieces attained by adding the value of the 4-bit data piece to the count values of 0 to 15 of each period represented by the signal SW.

For example, if a sequence of 2-bit data pieces having, consecutively, 2-bit data (0b01) representing a shift angle of 90° and 2-bit data (0b11) representing a shift angle of 270° is received as the transmission data signal TXD, first the combination circuit 13 of the modulation circuit 22 adds 4-bit data (0b0100) representing a shift angle of 90° that is the data signal TX outputted from the transmission data storage circuit 11 to each counter value of the signal SW constituted of a sequence of counter values 0, 1, 2 . . . 14, 15 outputted from the counter 12. As a result, the combination circuit 13 supplies a signal generated by shifting the phase of the signal SW by 90° to the sine wave generation circuit 14 as the signal IM.

Next, the combination circuit 13 of the modulation circuit 22 adds, to each counter value of the signal SW, 4-bit data (0b1100) representing a shift angle of 270° that is the data signal TX outputted from the transmission data storage circuit 11. As a result, the combination circuit 13 supplies a signal generated by shifting the phase of the signal SW by 270° to the sine wave generation circuit 14 as the signal IM.

In QPSK mode, the sine wave generation circuit 14 of the modulation circuit 22 converts the signal IM constituted of the sequence of 4-bit data pieces into the signal SIN constituted of a sequence of 8-bit data pieces according to the conversion table A shown in FIG. 4A, for example. In other words, the sine wave generation circuit 14 converts the sawtooth waveform represented in the signal IM into a sine waveform.

Here, each period of the signal IM corresponds to 16 count values from 0 to 15 of the counter 12, and thus, the numerical value 1 in the signal IM represents 22.5°, attained by dividing a phase angle of 360° for one period by 16.

Thus, as shown in the conversion table A of FIG. 4A, the values of the 4-bit data pieces in the signal IM including 0, 1, 2, 3 . . . 14, and 15 correspond, respectively, to the phase angles of 0°, 22.5°, 45°, 67.5° . . . 315°, and 337.5° of the sine wave. In this case, the values of sin θ (hereinafter referred to as the sin values) corresponding to phase angles of 0°, 22.5°, 45°, 67.5° . . . 315°, and 337.5° are, as shown in the conversion table A of FIG. 4A, 0.000, 0.383, 0.707, 0.924 . . . −0.707, and −0.383, respectively. Here, where the maximum sin value of 1 is represented by 127, as shown in the conversion table A of FIG. 4A, the binary value of a factor of 127 of each sin value of 0.000, 0.383, 0.707, 0.924 . . . −0.707, and −0.383 is an 8-bit data piece (including the sign bit) in the signal SIN.

At this time, in QPSK mode, the signal SIN generated by the modulation circuit 22 is supplied to the combination circuit 15 as a modulation signal attained by subjecting the carrier wave to QPSK modulation on the basis of the transmission data signal TXD.

In QPSK mode, the additional data signal αDD representing 4 as a decimal value is supplied to the combination circuit 15 of the modulation circuit 21. Also, as shown in FIG. 5, in QPSK mode, the sine wave generation circuit 14 of the modulation circuit 21 enters a state of supplying to the combination circuit 15 the signal SIN representing the 8-bit data (0x04), which represents a decimal value of 4. Additionally, in QPSK mode, the combination circuit 15 of the modulation circuits 21 and 22 operates as a multiplier. By multiplying a signal representing 8-bit data (0x04) representing a decimal value of 4, a calculation corresponding to a factor of 1 is performed. The transmission data storage circuit 11 and the counter 12 of the modulation circuit 21 do not output a signal due to being in a state where the operation thereof is stopped. The combination circuit 13, which is supplied the outputs of the transmission data storage circuit 11 and the counter 12, also enters a state where the operation thereof is stopped, and thus, does not output a signal. However, if a fixed value is outputted as the output of the sine wave generation circuit 14 regardless of the operation of the transmission data storage circuit 11, the counter 12, and the combination circuit 13, then the operational state of the transmission data storage circuit 11, the counter 12, and the combination circuit 13 is not limited.

Thus, the combination circuit 15 of the modulation circuit 12 outputs, from the output terminal OUt, the output signal OMS representing a decimal value of 16. As a result, the output signal OMS outputted from the modulation circuit 21 is supplied to the combination circuit 15 of the modulation circuit 22 via the additional data input terminal αDt of the modulation circuit 22.

Thus, the combination circuit 15 of the modulation circuit 22 outputs, from the output terminal OUt as the output signal OMS subjected to QPSK modulation, the multiplication results of multiplying the signal SIN supplied from the sine wave generation circuit 14 by the output signal OMS representing a value of 16 outputted from the modulation circuit 21.

In other words, in QPSK mode, the modulation module 200 outputs, as the modulation signal ENC, a signal attained by subjecting the carrier wave to QPSK modulation on the basis of the transmission data signal TXD. Also, in QPSK mode, the output signal OMS of the modulation circuit 21 can include a fixed value and be an auxiliary signal for the modulation circuit 22.

[ASK Mode]

As previously described, in order to cause the modulation module 200 to operate in ASK mode, the modulation mode signal MOD designating ASK mode is supplied to the modulation circuits 21 and 22 as shown in FIG. 2. Also, the individual setting signal X1 having a logic level of 1 is supplied to the modulation circuit 21 and the individual setting signal X2 having a logic level of 0 is supplied to the modulation circuit 22.

Additionally, the clock signal CLK having a frequency corresponding to the carrier wave frequency is supplied to the modulation circuits 21 and 22, and the additional data signal αDD representing 4 as a decimal value is supplied to the modulation circuit 21.

As a result, the modulation module 200 is set to an ASK mode operation state.

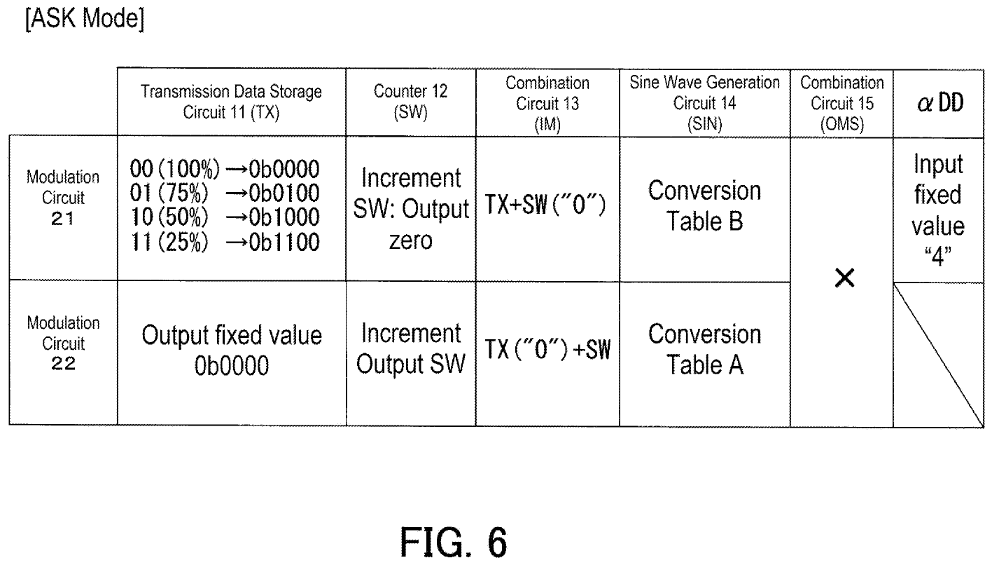

FIG. 6 shows the operational state of the transmission data storage circuit 11, the counter 12, the combination circuits 13 and 15, and the sine wave generation circuit 14 of each of the modulation circuits 21 and 22 during ASK mode.

In ASK mode, as shown in FIG. 6, the transmission data storage circuit 11 of the modulation circuit 21 receives and stores the transmission data signal TXD including a sequence of 2-bit data pieces representing 100%, 75%, 50%, and 25%, respectively, as the ratio of the amplitude size to the carrier wave. During this time, the transmission data storage circuit 11 reads the 2-bit data pieces in the order of being stored every time the carry out signal Co is supplied from the counter 12.

The transmission data storage circuit 11 of the modulation circuit 21 then converts the read out 2-bit data pieces to 4-bit data pieces as shown in FIG. 6.

That is, as shown in FIG. 6, the transmission data storage circuit 11 of the modulation circuit 21 converts each of the 2-bit data pieces to 4-bit data pieces representing 0, 4, 8, or 12 (all decimal values) according to the following correspondence relationships, and supplies the data signal TX constituted of the sequence of 4-bit data pieces to the combination circuit 13.

00 (100%)→0b0000

01 (75%)→0b0100

10 (50%)→0b1000

11 (25%)→0b1100

In ASK mode, the counter 12 of the modulation circuit 21 repeats the operation of incrementing the pulse count of the clock signal CLK corresponding to the carrier wave frequency from the initial count value of zero, and restoring the count value to the initial value of zero upon reaching the maximum count value of 15. As a result, the counter 12 generates the signal SW including the sequence of count values forming a sawtooth waveform. In ASK mode, the counter 12 of the modulation circuit 21 supplies, to the combination circuit 13, a signal SW representing a sequence of 4-bit data pieces fixed to zero (0b0000) regardless of the count value thereof.

In ASK mode, the combination circuit 13 of the modulation circuit 21 operates as an adder. The combination circuit 13 supplies, to the sine wave generation circuit 14 as the signal IM, a signal attained by adding the data signal TX constituted of a sequence of 4-bit data pieces outputted from the transmission data storage circuit 11 to the signal SW representing the zero value outputted from the counter 12. Thus, in reality, the data signal TX is supplied as is to the sine wave generation circuit 14 as the signal IM.

In ASK mode, the sine wave generation circuit 14 of the modulation circuit 21 converts the signal IM constituted of the sequence of 4-bit data pieces into the signal SIN constituted of a sequence of 8-bit data pieces according to the conversion table B shown in FIG. 4B, for example. In other words, in ASK mode, the sine wave generation circuit 14 of the modulation circuit 21 converts each of the 4-bit data pieces as the data signal TX represented in the signal IM to 8-bit data pieces having a value that represents the amplitude of the carrier wave as 100%, 75%, 50%, or 25%. At this time, the sine wave generation circuit 14 supplies, to the combination circuit 15, the signal SIN constituted of the sequence of data pieces attained by converting the 4-bit data pieces respectively to the 8-bit data pieces as described above.

In ASK mode, the additional data signal αDD representing 4 as a decimal value is supplied to the combination circuit 15 of the modulation circuit 21. Additionally, in ASK mode, the combination circuit 15 of the modulation circuit 21 operates as a multiplier.

Thus, the combination circuit 15 outputs the result of quadrupling the signal SIN from the output terminal OUt as the output signal OMS. As a result, the output signal OMS outputted from the modulation circuit 21 is supplied to the combination circuit 15 of the modulation circuit 22 via the additional data input terminal αDt of the modulation circuit 22.

Thus, in ASK mode, the modulation circuit 21 converts each 2-bit data piece to be transmitted that is included in the transmission data signal TXD to a sequence of 8-bit data pieces indicating the ratio of the amplitude when modulating the carrier wave, and supplies the sequence to the modulation circuit 22 as the output signal OMS. The output signal OMS of the modulation circuit 21 in ASK mode can include a modulation signal attained by subjecting the transmission data signal TXD to modulation processing.

The transmission data storage circuit 11 of the modulation circuit 22 does not perform an operation pertaining to the transmission data signal TXD during ASK mode, and as shown in FIG. 6, supplies the data signal TX representing zero (0b0000) as a fixed value to the combination circuit 13.

Also, in ASK mode, as shown in FIG. 6, the counter 12 of the modulation circuit 22 repeats the operation of incrementing the pulse count of the clock signal CLK corresponding to the carrier wave frequency from the initial count value of zero, and restoring the count value to the initial value of zero upon reaching the maximum count value of 15. As a result, the counter 12 generates the signal SW including the sequence of count values forming a sawtooth waveform, and supplies the signal SW to the combination circuit 13.

In ASK mode, the combination circuit 13 of the modulation circuit 22 operates as an adder. The combination circuit 13 adds the data signal TX representing zero (0b0000) to the signal SW. As a result, the combination circuit 13 supplies, to the sine wave generation circuit 14 as the signal IM, a signal that represents the sequence of count values included in the signal SW as a sequence of 4-bit data pieces.

In ASK mode, the sine wave generation circuit 14 of the modulation circuit 22 converts the signal IM constituted of the sequence of 4-bit data pieces into the signal SIN constituted of a sequence of 8-bit data pieces according to the conversion table A shown in FIG. 4A, for example. In other words, the sine wave generation circuit 14 converts the sawtooth waveform represented in the signal IM into a sine waveform.

Here, each period of the signal IM is represented by 16 count values from 0 to 15 of the counter 12, and thus, the numerical value 1 in the signal IM represents 22.5°, attained by dividing a phase angle of 360° of one period by 16.

Thus, as shown in the conversion table A of FIG. 4A, the values of the 4-bit data pieces in the signal IM including 0, 1, 2, 3 . . . 14, and 15 correspond, respectively, to the phase angles of 0°, 22.5°, 45°, 67.5° . . . 315°, and 337.5° of the sine wave. In this case, the values of sin θ (hereinafter referred to as the sin values) corresponding to phase angles of 0°, 22.5°, 45°, 67.5° . . . 315°, and 337.5° are, as shown in the conversion table A of FIG. 4A, 0.000, 0.383, 0.707, 0.924 . . . −0.707, and —0.383, respectively. Here, where the maximum sin value of 1.000 is represented by 127, as shown in the conversion table A of FIG. 4A, the binary value of a factor of 127 of each sin value of 0.000, 0.383, 0.707, 0.924 . . . —0.707, and −0.383 is an 8-bit data piece (including the sign bit) in the signal SIN.

The sine wave generation circuit 14 supplies the signal SIN to the combination circuit 15 as a modulation signal.

In ASK mode, the combination circuit 15 of the modulation circuit 22 has supplied thereto, as the additional data signal αDD, the output signal OMS generated by the modulation circuit 21, or in other words, a signal including a sequence of 8-bit data pieces representing the ratio of the amplitude when modulating the carrier wave. Additionally, in ASK mode, the combination circuit 15 of the modulation circuit 22 operates as a multiplier.

Thus, the combination circuit 15 of the modulation circuit 22 multiplies the signal SIN by the additional data signal αDD including the sequence of 8-bit data pieces representing the ratio of the amplitude when modulating the carrier wave, and outputs the output signal OMS representing the multiplication results from the output terminal OUt.

If, for example, a sequence having, consecutively, 8-bit data (0b00000011) representing 75% as the ratio of the amplitude and 8-bit data (0b00000010) representing 50% is received as the additional data signal αDD, for example, the combination circuit 15 of the modulation circuit 22 first outputs, as the output signal OMS, the sequence of 8-bit data pieces attained by multiplying by 0.75 the 16 consecutive data values (0, 49, 90 . . . −90, −49) in the signal SIN indicated in the conversion table A of FIG. 4A.

Next, the combination circuit 15 of the modulation circuit 22 outputs, as the output signal OMS, the sequence of 8-bit data pieces attained by multiplying by 0.5 the 16 consecutive data values (0, 49, 90 . . . −90, −49) in the signal SIN indicated in the conversion table A of FIG. 4A.

As a result, in ASK mode, the modulation module 200 outputs, as the modulation signal ENC, a signal attained by subjecting the output signal OMS outputted from the modulation circuit 22 to ASK modulation of the carrier wave on the basis of the transmission data signal TXD.

[FSK Mode]

As previously described, in order to cause the modulation module 200 to operate in FSK mode, the modulation mode signal MOD designating FSK mode is supplied to the modulation circuits 21 and 22 as shown in FIG. 2. Also, the individual setting signal X1 having a logic level of 1 is supplied to the modulation circuit 21 and the individual setting signal X2 having a logic level of 0 is supplied to the modulation circuit 22.

Additionally, the clock signal CLK having a frequency corresponding to the carrier wave frequency is supplied to the modulation circuits 21 and 22, and the additional data signal αDD representing 4 as a decimal value is supplied to the modulation circuit 21.

As a result, the modulation module 200 is set to an FSK mode operation state.

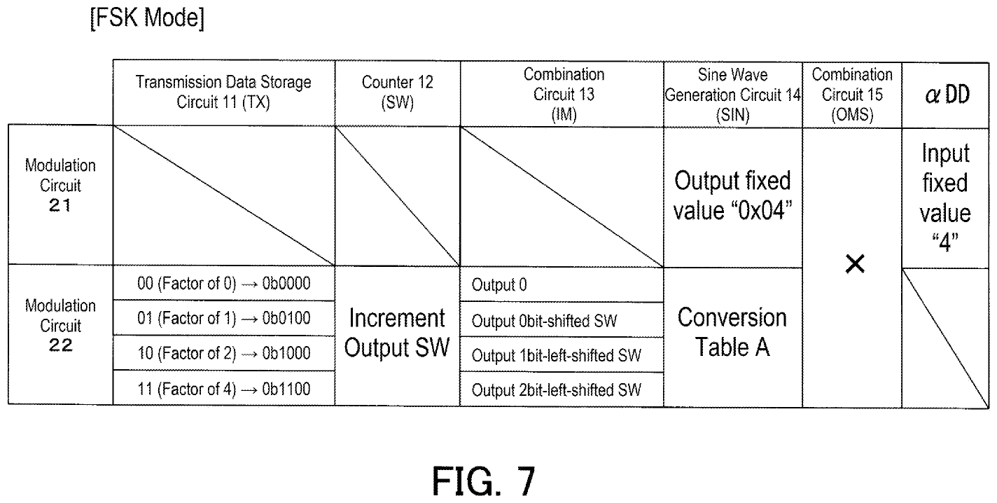

FIG. 7 shows the operational state of the transmission data storage circuit 11, the counter 12, the combination circuits 13 and 15, and the sine wave generation circuit 14 of each of the modulation circuits 21 and 22 during FSK mode.

In FSK mode, as shown in FIG. 7, the transmission data storage circuit 11 of the modulation circuit 22 receives and stores the transmission data signal TXD including a sequence of the 2-bit data pieces representing a factor of 0, a factor of 1, a factor of 2, or a factor of 4 as factors of the carrier wave frequency. During this time, the transmission data storage circuit 11 reads the 2-bit data pieces in the order of being stored every time the carry out signal Co is supplied from the counter 12.

The transmission data storage circuit 11 of the modulation circuit 22 then converts the read out 2-bit data pieces to 4-bit data pieces as shown in FIG. 7.

That is, as shown in FIG. 7, the transmission data storage circuit 11 of the modulation circuit 22 converts each of the 2-bit data pieces to 4-bit data pieces representing 0, 4, 8, or 12 (all decimal values) according to the following correspondence relationships, and supplies the data signal TX constituted of the sequence of 4-bit data pieces to the combination circuit 13.

00 (factor of 0)→0b0000

01 (factor of 1)→0b0100

10 (factor of 2)→0b1000

11 (factor of 4)→0b1100

In FSK mode, the counter 12 of the modulation circuit 22 repeats the operation of incrementing the pulse count of the clock signal CLK corresponding to the carrier wave frequency from the initial count value of zero, and restoring the count value to the initial value of zero upon reaching the maximum count value of 15. As a result, the counter 12 generates the signal SW including the sequence of count values forming a sawtooth waveform, and supplies the signal SW to the combination circuit 13.

In FSK mode, the combination circuit 13 of the modulation circuit 22 operates as a multiplier that multiplies the signal SW by a factor of 0, 1, 2, or 4 based on the data signal TX. Every time a 4-bit data piece is outputted from the transmission data storage circuit 11, the combination circuit 13 supplies, to the sine wave generation circuit 14, the signal IM including a sequence of 16 4-bit data pieces attained by multiplying the value of the 4-bit data piece by the count values of 0 to 15 of each period represented by the signal SW.

For example, if a sequence of bit data pieces having, consecutively, bit data (0b01) representing a factor of 1 and bit data (0b10) representing a factor of 2 is received as the transmission data signal TXD, first the combination circuit 13 of the modulation circuit 22 multiplies a factor of 1 corresponding to the data signal TX (0b0100) outputted from the transmission data storage circuit 10 to each counter value of the signal SW constituted of a sequence of counter values 0, 1, 2 . . . 14, 15 outputted from the counter 12. That is, at this time, the combination circuit 13 supplies a signal generated by shifting each bit of the signal SW by 0 bits, or in other words, supplies the signal SW as is to the sine wave generation circuit 14 as the signal IM. As a result, the combination circuit 13 supplies, to the sine wave generation circuit 14, the signal IM constituted of a sequence of 4-bit data pieces that are a factor of 1 of the sequence of counter values of the signal SW.

Next, the combination circuit 13 of the modulation circuit 22 multiplies each counter value of the signal SW by a factor of 2 corresponding to 4-bit data (0b1000) representing a factor of 2 outputted from the transmission data storage circuit 11. That is, at this time, the combination circuit 13 supplies a signal generated by shifting each bit of the signal SW by 1 bit to the left to the sine wave generation circuit 14 as the signal IM.

Next, the combination circuit 13 of the modulation circuit 22 multiplies each counter value of the signal SW by a factor of 4 corresponding to 4-bit data (0b1100) representing a factor of 4 outputted from the transmission data storage circuit 11. That is, at this time, the combination circuit 13 supplies a signal generated by shifting each bit of the signal SW by 2 bits to the left to the sine wave generation circuit 14 as the signal IM.

Also, if the combination circuit 13 of the modulation circuit 22 multiplies the signal SW by a factor of 0 corresponding to 4-bit data (0b0000) representing a factor of 0 outputted from the transmission data storage circuit 11, a signal IM representing zero (0b0000) is supplied to the sine wave generation circuit 14.

In FSK mode, the sine wave generation circuit 14 of the modulation circuit 22 converts the signal IM constituted of the sequence of 4-bit data pieces into the signal SIN constituted of a sequence of 8-bit data pieces according to the conversion table A shown in FIG. 4A, for example. In other words, the sine wave generation circuit 14 converts the sawtooth waveform represented in the signal IM into a sine waveform.

Here, each period of the signal IM corresponds to 16 count values from 0 to 15 of the counter 12, and thus, the numerical value 1 in the signal IM represents 22.5°, attained by dividing a phase angle of 360° for one period by 16.

Thus, as shown in the conversion table A of FIG. 4A, the values of the 4-bit data pieces in the signal IM including 0, 1, 2, 3 . . . 14, and 15 correspond, respectively, to the phase angles of 0°, 22.5°, 45°, 67.5° . . . 315°, and 337.5° of the sine wave. In this case, the values of sin θ (hereinafter referred to as the sin values) corresponding to phase angles of 0°, 22.5°, 45°, 67.5° . . . 315°, and 337.5° are, as shown in the conversion table A of FIG. 4A, 0.000, 0.383, 0.707, 0.924 . . . −0.707, and −0.383, respectively. Here, where the maximum sin value of 1 is represented by 127, as shown in the conversion table A of FIG. 4A, the binary value of a factor of 127 of each sin value of 0.000, 0.383, 0.707, 0.924 . . . −0.707, and −0.383 is an 8-bit data piece (including the sign bit) in the signal SIN.

In this case, in FSK mode, the factor of the carrier wave represented by the 4-bit data pieces included in the data signal TX determines the factor of the data value in the sequence of 8-bit data pieces included in the signal SIN. As a result, the greater the factor represented by the 4-bit data pieces included in the data signal TX is, the greater the frequency of the sine wave of the sequence of 8-bit data pieces included in the signal SIN.

In other words, in FSK mode, the signal SIN outputted from the combination circuit 13 of the modulation circuit 22 is supplied to the combination circuit 15 as a modulation signal attained by subjecting the carrier wave to FSK modulation on the basis of the transmission data signal TXD.

In FSK mode, the additional data signal αDD representing 4 as a decimal value is supplied to the combination circuit 15 of the modulation circuit 21. Also, as shown in FIG. 7, in FSK mode, the sine wave generation circuit 14 of the modulation circuit 21 enters a state of supplying to the combination circuit 15 the signal SIN representing the 8-bit data (0x04), which represents a decimal value of 4. Additionally, in FSK mode, the combination circuit 15 of the modulation circuits 21 and 22 operates as a multiplier. By multiplying a signal representing 8-bit data (0x04) representing a decimal value of 4, a calculation corresponding to a factor of 1 is performed. The transmission data storage circuit 11 and the counter 12 of the modulation circuit 21 do not output a signal due to being in a state where the operation thereof is stopped. The combination circuit 13, which is supplied the outputs of the transmission data storage circuit 11 and the counter 12, also enters a state where the operation thereof is stopped, and thus, does not output a signal. However, if a fixed value is outputted as the output of the sine wave generation circuit 14 regardless of the operation of the transmission data storage circuit 11, the counter 12, and the combination circuit 13, then the operational state of the transmission data storage circuit 11, the counter 12, and the combination circuit 13 is not limited.

Thus, the combination circuit 15 of the modulation circuit 12 outputs, from the output terminal OUt, the output signal OMS representing a decimal value of 16. As a result, the output signal OMS outputted from the modulation circuit 21 is supplied to the combination circuit 15 of the modulation circuit 21 via the additional data input terminal αDt of the modulation circuit 22.

Thus, the combination circuit 15 of the modulation circuit 22 outputs, from the output terminal OUt as the output signal OMS, the multiplication results of multiplying the signal SIN supplied from the sine wave generation circuit 14 by the output signal OMS representing a value of 16 outputted from the modulation circuit 21.

In other words, in FSK mode, the modulation module 200 outputs, as the modulation signal ENC, a signal attained by subjecting the carrier wave to FSK modulation on the basis of the transmission data signal TXD. Also, in FSK mode, the output signal OMS of the modulation circuit 21 can include a fixed value and be an auxiliary signal for the modulation circuit 22.

[16 QAM Mode]

As previously described, in order to cause the modulation module 200 to operate in 16 QAM mode, the modulation mode signal MOD designating 16 QAM mode is supplied to the modulation circuits 21 and 22 as shown in FIG. 2. Also, the individual setting signal X1 having a logic level of 1 is supplied to the modulation circuit 21 and the individual setting signal X2 having a logic level of 0 is supplied to the modulation circuit 22.

Additionally, the clock signal CLK having a frequency corresponding to the carrier wave frequency is supplied to the modulation circuits 21 and 22, and the additional data signal αDD representing 4 as a decimal value is supplied to the modulation circuit 21.

As a result, the modulation module 200 is set to a 16 QAM mode operation state.

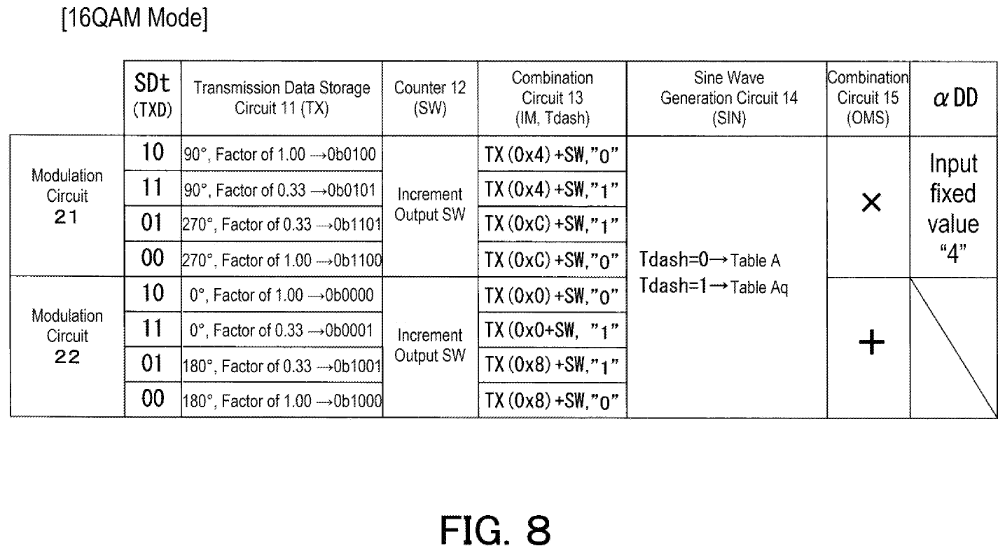

FIG. 8 shows the operational state of the transmission data storage circuit 11, the counter 12, the combination circuits 13 and 15, and the sine wave generation circuit 14 of each of the modulation circuits 21 and 22 during 16 QAM mode.

In 16 QAM mode, as shown in FIG. 8, the transmission data storage circuit 11 of each of the modulation circuits 21 and 22 receives the transmission data signal TXD including 10, 11, 01, and 00 as 2-bit data pieces via the transmission data input terminal SDt.

In this case, the transmission data storage circuit 11 of the modulation circuit 21 receives the 2-bit data pieces 10, 11, 01, and 00 represented in the transmission data signal TXD as signals that have a shift angle of 90° or 270° with respect to the carrier wave frequency and that are a factor of 1.00 or 0.33 of the amplitude of the carrier wave, as described below.

10: (90°, factor of 1.00)

11: (90°, factor of 0.33)

01: (270°, factor of 0.33)

00: (270°, factor of 1.00)

The transmission data storage circuit 11 of the modulation circuit 21 stores the transmission data signal TXD including the sequence of 2-bit data pieces described above, and reads the 2-bit data pieces in the order of being stored every time the carry out signal Co is supplied from the counter 12.

The transmission data storage circuit 11 of the modulation circuit 21 then converts the read out 2-bit data pieces to 4-bit data pieces as shown in FIG. 8. That is, as shown in FIG. 8, the transmission data storage circuit 11 of the modulation circuit 21 converts each of the 2-bit data pieces to 4-bit data pieces representing 4, 5, 13, or 12 (all decimal values) according to the following correspondence relationships, and supplies the data signal TX constituted of the sequence of 4-bit data pieces to the combination circuit 13.

10 (90°, factor of 1.00)→0b0100

11 (90°, factor of 0.33)→0b0101

01 (270°, factor of 0.33)→0b1101

00 (270°, factor of 1.00)→0b1100

Also, as shown in FIG. 8, in 16 QAM Mode, the transmission data storage circuit 11 of the modulation circuit 22 receives the 2-bit data pieces 10, 11, 01, and 00 represented in the transmission data signal TXD as signals that have a shift angle of 0° or 180° with respect to the carrier wave frequency and that are a factor of 1.00 or 0.33 of the amplitude of the carrier wave, as described below.

10: (0°, factor of 1.00)

11: (0°, factor of 0.33)

01: (180°, factor of 0.33)

00: (180°, factor of 1.00)

The transmission data storage circuit 11 of the modulation circuit 22 stores the transmission data signal TXD including the sequence of 2-bit data pieces described above, and reads the 2-bit data pieces in the order of being stored every time the carry out signal Co is supplied from the counter 12.

The transmission data storage circuit 11 of the modulation circuit 22 then converts the read out 2-bit data pieces to 4-bit data pieces as shown in FIG. 8. That is, as shown in FIG. 8, the transmission data storage circuit 11 of the modulation circuit 22 converts each of the 2-bit data pieces to 4-bit data pieces representing 0, 1, 9, or 8 (all decimal values) according to the following correspondence relationships, and supplies the data signal TX constituted of the sequence of 4-bit data pieces to the combination circuit 13.

10 (0°, factor of 1.00)→0b0000

11 (0°, factor of 0.33)→0b0001

01 (180°, factor of 0.33)→0b1001

00 (180°, factor of 1.00)→0b1000

In 16 QAM mode, each counter 12 of the modulation circuits 21 and 22 repeats the operation of incrementing the pulse count of the clock signal CLK corresponding to the carrier wave frequency from the initial count value of zero, and restoring the count value to the initial value of zero upon reaching the maximum count value of 15. As a result, the counter 12 generates the signal SW including the sequence of count values forming a sawtooth waveform, and supplies the signal SW to the combination circuit 13.

In 16 QAM mode, the combination circuit 13 of each of the modulation circuits 21 and 22 adds, to the signal SW, a value attained by replacing only the value of the least significant bit of the 4-bit data signal TX with a logic level of 0, and supplies the signal IM representing the addition result to the sine wave generation circuit 14. Additionally, the combination circuit 13 supplies the 1-bit signal Tdash representing the logic level of the least significant bit of the data signal TX to the sine wave generation circuit 14.

If, for example, 10 is received as a 2-bit data piece included in the transmission data signal TXD, the combination circuit 13 of the modulation circuit 21 adds a 4-bit data signal TX (0x4) to the signal SW constituted of the sequence of counter values of 0 to 15. The combination circuit 13 then supplies the signal IM representing the addition results to the sine wave generation circuit 14. Additionally, during this time, the combination circuit 13 of the modulation circuit 21 supplies the signal Tdash representing the logic level 0 of the least significant bit of the 4-bit data signal TX (0x4) to the sine wave generation circuit 14.

Also, if 10 is received as a 2-bit data piece included in the transmission data signal TXD, the combination circuit 13 of the modulation circuit 22 adds a 4-bit data signal TX (0x0) to the signal SW constituted of the sequence of counter values of 0 to 15. The combination circuit 13 then supplies the signal IM representing the addition results to the sine wave generation circuit 14. Additionally, during this time, the combination circuit 13 of the modulation circuit 22 supplies the signal Tdash representing the logic level 0 of the least significant bit of the 4-bit data signal TX (0x0) to the sine wave generation circuit 14.

Also, if 01 is received as a 2-bit data piece included in the transmission data signal TXD, the combination circuit 13 of the modulation circuit 21 adds a data signal TX (0xC), in which the least significant bit of a 4-bit data signal TX (0xD) is replaced with a logic level of 0, to the signal SW constituted of the sequence of counter values of 0 to 15. The combination circuit 13 then supplies the signal IM representing the addition results to the sine wave generation circuit 14. Additionally, during this time, the combination circuit 13 of the modulation circuit 21 supplies the signal Tdash representing the logic level 1 of the least significant bit of the 4-bit data signal TX (0xD) to the sine wave generation circuit 14.

Also, if 01 is received as a 2-bit data piece included in the transmission data signal TXD, the combination circuit 13 of the modulation circuit 22 adds a data signal TX (0x8), in which the least significant bit of a 4-bit data signal TX (0x9) is replaced with a logic level of 0, to the signal SW constituted of the sequence of counter values of 0 to 15. The combination circuit 13 then supplies the signal IM representing the addition results to the sine wave generation circuit 14. Additionally, during this time, the combination circuit 13 of the modulation circuit 22 supplies the signal Tdash representing the logic level 1 of the least significant bit of the 4-bit data signal TX (0x9) to the sine wave generation circuit 14.

In 16 QAM mode, as shown in FIG. 8, if the signal Tdash represents a logic level of 0, the sine wave generation circuit 14 of the modulation circuits 21 and 22 converts the signal IM constituted of the sequence of 4-bit data pieces into the signal SIN constituted of a sequence of 8-bit data pieces according to the conversion table A shown in FIG. 4A, for example. On the other hand, if the signal Tdash represents a logic level of 1, the sine wave generation circuit 14 of the modulation circuits 21 and 22 converts the signal IM constituted of the sequence of 4-bit data pieces into the signal SIN constituted of a sequence of 8-bit data pieces according to the conversion table Aq shown in FIG. 4A, for example.

Here, each period of the signal IM corresponds to 16 count values from 0 to 15 of the counter 12, and thus, the numerical value 1 in the signal IM represents 22.5°, attained by dividing a phase angle of 360° for one period by 16.

Thus, as shown in FIG. 4A, the values of the 4-bit data pieces in the signal IM including 0, 1, 2, 3 . . . 14, and 15 correspond, respectively, to the phase angles of 0°, 22.5°, 45°, 67.5° . . . 315°, and 337.5° of the sine wave. In this case, the values of sin θ (hereinafter referred to as the sin values) corresponding to phase angles of 0°, 22.5°, 45°, 67.5° . . . 315°, and 337.5° are, as shown in FIG. 4A, 0.000, 0.383, 0.707, 0.924 . . . −0.707, and −0.383, respectively. Here, where the maximum sin value of 1 is represented by 127, as shown in the conversion table A of FIG. 4A, the binary value of a factor of 127 of each sin value of 0.000, 0.383, 0.707, 0.924 . . . −0.707, and −0.383 is an 8-bit data piece (including the sign bit) in the signal SIN.

On the other hand, where the maximum sin value of 1 is represented by 42, as shown in the conversion table Aq of FIG. 4A, the binary value of a factor of 42 of each sin value of 0.000, 0.383, 0.707, 0.924 . . . −0.707, and −0.383 is an 8-bit data piece (including the sign bit) in the signal SIN.

Thus, the sine wave generation circuit 14 of the modulation circuit 21 supplies the signal SIN generated as described above to the combination circuit 15 of the modulation circuit 21. Also, the sine wave generation circuit 14 of the modulation circuit 22 supplies the signal SIN generated as described above to the combination circuit 15 of the modulation circuit 22 as a modulation signal.

In 16 QAM mode, the combination circuit 15 of the modulation circuit 22 operates as a multiplier as shown in FIG. 8 and the combination circuit 15 of the modulation circuit 22 operates as an adder. Here, the additional data signal αDD representing 4 as a decimal value is supplied to the combination circuit 15 of the modulation circuit 21. Thus, the combination circuit 15 of the modulation circuit 21 outputs, from the output terminal OUt, the output signal OMS representing the multiplication results of multiplying the signal SIN outputted from the sine wave generation circuit 14 by 4, which is the value of the additional data signal αDD. The output signal OMS of the modulation circuit 21 in 16 QAM mode can include a modulation signal attained by subjecting the transmission data signal TXD to modulation processing. The output signal OMS outputted from the modulation circuit 21 is supplied to the combination circuit 15 of the modulation circuit 22 via the additional data input terminal αDt of the modulation circuit 22. Thus, the combination circuit 15 of the modulation circuit 22 outputs, from the output terminal OUt as the output signal OMS, the addition results of adding the output signal OMS (SIN×4) outputted from the modulation circuit 21 to the signal SIN supplied from the sine wave generation circuit 14.

As a result of this operation, the modulation module 200 outputs, as the modulation signal ENC, a signal attained by subjecting the carrier wave to 16 QAM on the basis of the transmission data signal TXD.

Here, the operation of the combination circuit 15 included in the modulation module 200 will be explained.

The combination circuit 15 included in the modulation circuit 21 outputs, to the modulation circuit 22 as the output signal OMS, a signal attained by combining a signal representing a prescribed fixed value or a first modulation signal resulting from modulation of the transmission data signal TXD on the basis of setting information including the individual setting signal X1 and the modulation mode signal MOD designating the modulation mode, with the additional data signal αDD as an external signal inputted from the outside.

The combination circuit 15 included in the modulation circuit 22 outputs, as the output signal ENC, a signal generated by combining a signal representing the second modulation signal generated by subjecting the transmission data signal TXD to modulation processing based on the above-mentioned setting information with an output signal outputted from the modulation circuit 21.

The combination circuits 15 need not necessarily be disposed in different modulation circuits, and a configuration may be adopted in which the combination circuits 15 are disposed and connected in the same modulation circuit.

Thus, according to the modulation module 200, it is possible to generate a modulation signal generated by subjecting a carrier wave to modulation processing in a modulation mode designated by the modulation mode signal MOD, among the plurality of modulation modes.

Also, a configuration may be adopted in which the operation of the modulation circuit 22 of the modulation module 200 is stopped, and the transmission data signal TXD is supplied to the modulation circuit 21 in order to change the logic level of the individual setting signal X1 inputted via the operation setting terminal Xt, thereby performing QPSK modulation and FSK modulation with only the modulation circuit 21. In other words, it is possible to perform QPSK modulation and FSK modulation with only the modulation module having the configuration shown in FIG. 3.

Also, each modulation circuit (21, 22) includes the combination circuits 13 and 15 that can select one of addition and multiplication according to the modulation mode signal MOD, but the configuration of the combination circuits 13 and 15 is not limited to a specific circuit.

For example, the combination circuits 13 and 15 may adopt a configuration including an adder and a multiplier as well as a selector that selects and outputs the output from the adder or the multiplier according to the modulation mode signal MOD, or may adopt an adder/multiplier circuit that incorporates both multiplication and adding functions.

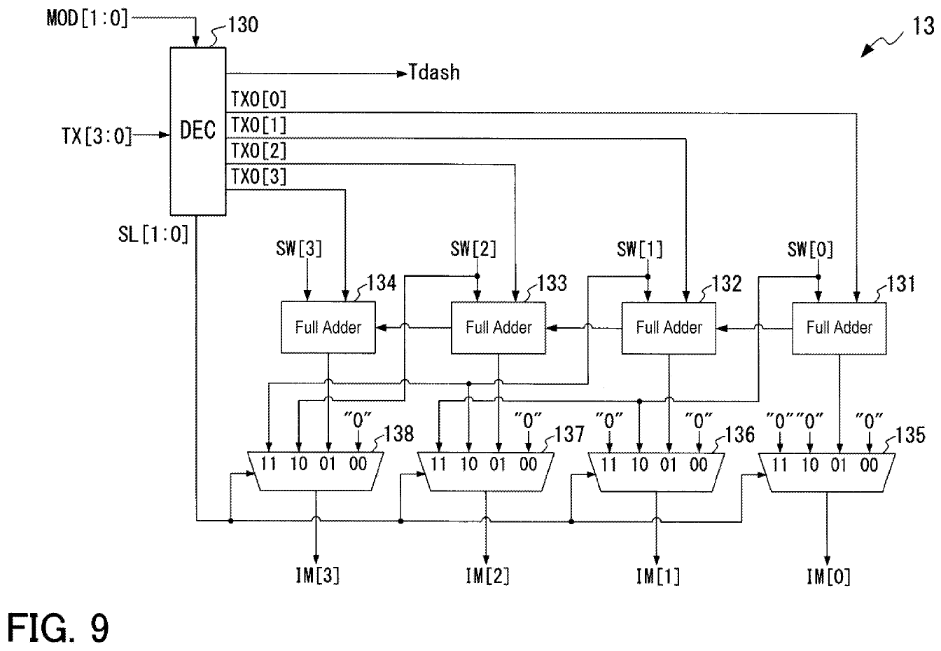

FIG. 9 is a circuit diagram showing an example of an internal configuration of the combination circuit 13.

The combination circuit 13 shown in FIG. 9 includes a decoder 130, full adders 131 to 134, and selectors 135 to 138.

The decoder 130 receives the above-mentioned 2-bit modulation mode signal MOD and 4-bit data signal TX. The 2-bit modulation mode signal MOD is referred to as MOD[1:0] and the 4-bit data signal TX is referred to as TX[3:0].

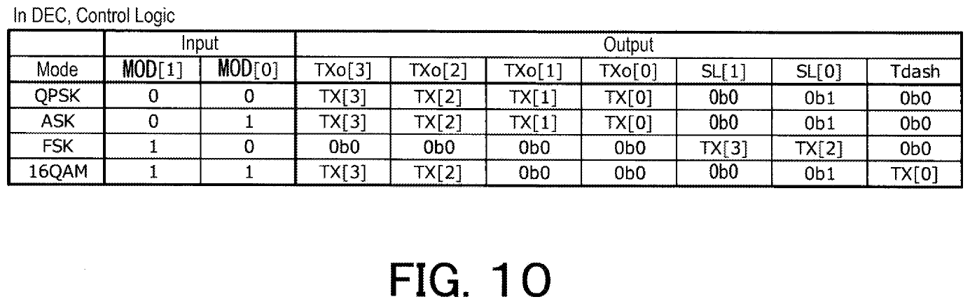

The decoder 130 operates according to the truth table shown in FIG. 10 in outputting a 2-bit selection signal SL[1:0], a signal Tdash, and output bits TXO[0] to TXO[3] on the basis of the modulation mode signal MOD[1:0] and the data signal TX[3:0].

In other words, as shown in FIG. 10, if the modulation mode signal MOD designates QPSK mode or ASK mode, the decoder 130 outputs TX[3] indicating the most significant bit in the data signal TX[3:0] as the output bit TXO[3], outputs TX[2] as the output bit TXO[2], outputs TX[1] as the output bit TXO[1], and outputs TX[0] as the output bit TXO[0]. Also, if the modulation mode signal MOD designates QPSK mode or ASK mode, the decoder 130 outputs a selection signal SL[0] at a logic level of 1 (0b1), a selection signal SL[1] at a logic level of 0 (0b0), and a signal Tdash at a logic level of 0 (0b0).

Additionally, as shown in FIG. 10, if the modulation mode signal MOD designates FSK mode, the decoder 130 outputs the output bits TXO[0] to TXO[3] at a logic level of 0 (0b0). Also, if the modulation mode signal MOD designates FSK mode, the decoder 130 outputs TX[3] among the data signals TX[3:0] as the selection signal SL[1] and TX[2] as the selection signal SL[0], and outputs the signal Tdash at a logic level of 0 (0b0).

Additionally, as shown in FIG. 10, if the modulation mode signal MOD designates 16 QAM mode, the decoder 130 outputs TX[3] in the data signal TX[3:0] as the output bit TXO[3], outputs TX[2] as the output bit TXO[2], outputs the output bit TXO[1] at a logic level of 0(0b0), and outputs the output bit TXO[0] at a logic level of 0 (0b0). Also, if the modulation mode signal MOD designates 16 QAM mode, the decoder 130 outputs the selection signal SL[0] at a logic level of 1 (0b1), the selection signal SL[1] at a logic level of 0 (0b0), and the least significant TX[0] bit among the data signal TX[3:0] as the signal Tdash.

As shown in FIG. 9, the full adder 131 adds the output bit TXO[0] outputted from the decoder 130 to the signal SW[0] indicating the least significant bit of the 4-bit signal SW[3:0] outputted from the counter 12. Then, the full adder 131 supplies the addition results to the input terminal [01] of the selector 135 and supplies a carry bit to the full adder 132.

The full adder 132 adds together the carry bit supplied from the full adder 131, the output bit TXO[1] outputted from the decoder 130, and the signal SW[1] of the 4-bit signal SW[3:0] outputted from the counter 12. Then, the full adder 132 supplies the addition results to the input terminal [01] of the selector 136 and supplies a carry bit to the full adder 133.

The full adder 133 adds together the carry bit supplied from the full adder 132, the output bit TXO[2] outputted from the decoder 130, and the signal SW[2] of the 4-bit signal SW[3:0] outputted from the counter 12. Then, the full adder 133 supplies the addition results to the input terminal [01] of the selector 137 and supplies a carry bit to the full adder 134.

The full adder 134 adds together the carry bit supplied from the full adder 133, the output bit TXO[3] outputted from the decoder 130, and the signal SW[3], which is the most significant bit of the 4-bit signal SW[3:0] outputted from the counter 12. Then, the full adder 134 supplies the addition results to the input terminal [01] of the selector 137.

The selectors 135 to 138 each have an input terminal [00], an input terminal [10], and an input terminal [11] in addition to the aforementioned input terminal [01].

The input terminals [00], [10], and [11] of the selector 135 have supplied thereto a fixed signal with a logic level of 0 (0b0). The input terminals [00] and [11] of the selector 136 have supplied thereto a fixed signal with a logic level of 0 (0b0), and the input terminal [10] has the above-mentioned signal SW[0] supplied thereto. The input terminal [00] of the selector 137 has supplied thereto a fixed signal with a logic level of 0 (0b0), the input terminal [10] has the above-mentioned signal SW[1] supplied thereto, and the input terminal [11] has the above-mentioned signal SW[0] supplied thereto. The input terminal [00] of the selector 138 has supplied thereto a fixed signal with a logic level of 0 (0b0), the input terminal [10] has the above-mentioned signal SW[2] supplied thereto, and the input terminal [11] has the above-mentioned signal SW[1] supplied thereto.

Each of the selectors 135 to 138 selects one of the input terminals [00] to [11] according to the selection signal SL[1:0] supplied from the decoder 130, and outputs the signal of the selected input terminal.

In other words, each of the selectors 135 to 138 selects and outputs the signal of the input terminal [00] if the 2 bits of the selection signal SL[1:0] both have a logic level of 0 (0b0). Also, each of the selectors 135 to 138 selects and outputs the signal of the input terminal [01] if the 2 bits of the selection signal SL[1:0] respectively have a logic level of 0 (0b0) and a logic level of 1 (0b1). Additionally, each of the selectors 135 to 138 selects and outputs the signal of the input terminal [10] if the 2 bits of the selection signal SL[1:0] respectively have a logic level of 1 (0b1) and a logic level of 0 (0b0). Each of the selectors 135 to 138 selects and outputs the signal of the input terminal [11] if the 2 bits of the selection signal SL[1:0] both have a logic level of 1 (0b1).

In this case, the selector 135 supplies the signal outputted as described above to the sine wave generation circuit 14 as the signal IM[0] indicating the least significant bit of the signal IM. The selector 136 supplies the signal outputted as described above to the sine wave generation circuit 14 as the signal IM[1] indicating the second least significant bit of the signal IM. The selector 137 supplies the signal outputted as described above to the sine wave generation circuit 14 as the signal IM[2] indicating the third least significant bit of the signal IM. The selector 138 supplies the signal outputted as described above to the sine wave generation circuit 14 as the signal IM[3] indicating the most significant bit of the signal IM.

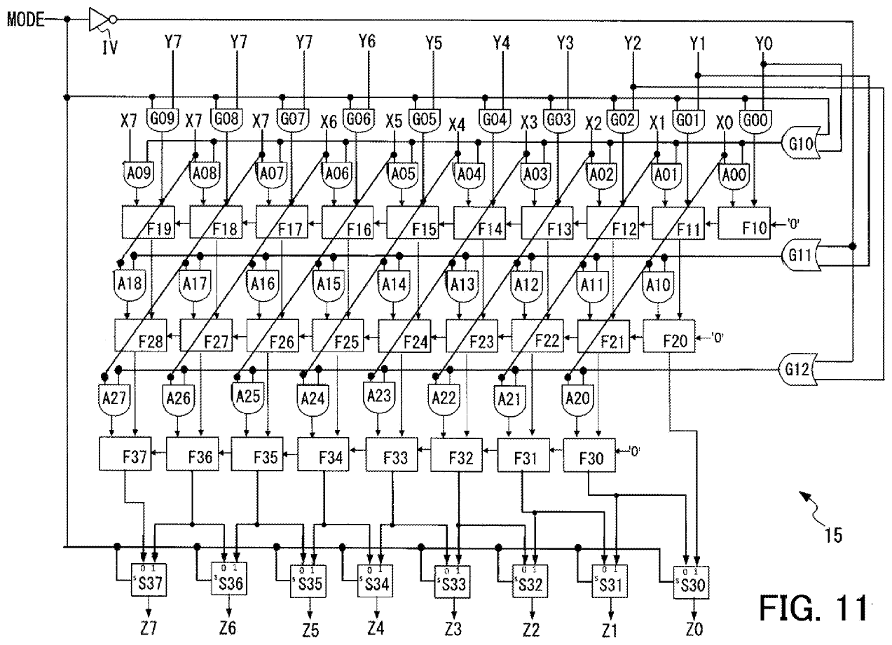

FIG. 11 is a circuit diagram showing an example of an internal configuration of a combination circuit 15.

FIG. 11 shows an example of the combination circuit 15 in which the result of multiplying or adding the 8-bit input data bits X0 to X7 by/to the 8-bit input data bits Y0 to Y7 is outputted as the output data bits Z0 to Z7. The input data bits Y0 to Y7 correspond to the 8-bit additional data signal αDD.

The circuit shown in FIG. 11 has AND elements A00 to A09, A10 to A18, A20 to A27, G00 to G09, G11, and G12, an OR element G10, full adders F10 to F19, F20 to F28, and F30 to F37, selectors S30 to S37, and an inverter IV.

The inverter IV receives a computation mode signal MODE having a logic level of 0 indicating multiplication mode or a logic level of 1 indicating addition mode. The inverter IV supplies, to the AND elements G11 and G12, an inverted computation mode signal generated by inverting the logic level of the computation mode signal MODE.

If the computation mode signal has a logic level of 1, the AND elements G00 to G07 supply the input data bits Y0 to Y7 to the full adders F10 to F17 as shown in FIG. 11. On the other hand, if the computation mode signal has a logic level of 0, the AND elements G00 to G07 supply a signal with a logic level of 0 to the full adders F10 to F17.

If the computation mode signal has a logic level of 1, the AND element G08 supplies the input data bit Y7 to the full adder F18. On the other hand, if the computation mode signal has a logic level of 0, the AND element G08 supplies a signal with a logic level of 0 to the full adder F18.

If the computation mode signal has a logic level of 1, the AND element G09 supplies the input data bit Y7 to the full adder F19. On the other hand, if the computation mode signal has a logic level of 0, the AND element G09 supplies a signal with a logic level of 0 to the full adder F19.

If both the computation mode signal MODE and the input data bit Y0 have a logic level 0, the OR element G10 supplies a signal with a logic level of 0 to the AND elements A00 to A09. On the other hand, if the computation mode signal MODE or the input data bit Y0 has a logic level of 1, the OR element G10 supplies a signal with a logic level of 1 to the AND elements A00 to A09.

The AND elements A00 to A07 supply to the respective full adders F10 to F17 the logical conjunction of the output from the OR element G10 and the value of each of the input data bits X0 to X7. The AND element A08 supplies to the full adder F18 the logical conjunction of the output from the OR element G10 and the value of the input data bit X7. The AND element A09 supplies to the full adder F19 the logical conjunction of the output from the OR element G10 and the value of the input data bit X7.

The full adders F10 to F17 supply, to the respective full adders F20 to F26, the bit signals of the seven most significant bits of the 8-bit signal representing the addition results of adding an 8-bit signal constituted of the outputs from the AND elements A00 to A07 to an 8-bit signal constituted of the outputs of the AND elements G00 to G07. Additionally, the full adders F10 to F17 supply carry bits to the full adders F11 to F18. The full adder F10 is supplied a fixed value of 0. The full adder F18 supplies the carry bit to the full adder F19 as well as supplying, to the full adder F27, the addition results of adding the output signal from the AND element A08 to the output signal from the AND element G08. The full adder F19 supplies, to the full adder F28, the addition results of adding the output signal from the AND element A09 to the output signal from the AND element G09.

If both the inverted computation mode signal and the input data bit Y1 have a logic level 1, the AND element G11 supplies a signal with a logic level of 1 to the AND elements A10 to A19. On the other hand, if the inverted computation mode signal or the input data bit Y1 has a logic level of 0, a signal with a logic level of 0 is supplied to the AND elements A10 to A18.

The AND elements A10 to A17 supply to the respective full adders F20 to F27 the logical conjunction of the output from the AND element G11 and the value of each of the input data bits X0 to X7. The AND element A18 supplies to the full adder F28 the logical conjunction of the output from the AND element G11 and the value of the input data bit X7.

The full adders F20 to F28 add a 9-bit signal constituted of the outputs from the full adders F11 to F19 to a 9-bit signal constituted of the outputs from the AND elements A10 to A18. In this case, the full adder F20 supplies the addition result thereof to the selector S30, and supplies an 8-bit signal indicating the addition results of the full adders F21 to F28 to the full adders F30 to F37. Additionally, the full adders F20 to F27 supply carry bits to the full adders F21 to F28. The full adder F20 is supplied a fixed value of 0.

The AND element G12 supplies the logical conjunction of the inverted computation mode signal and the input data bit Y2 to the AND elements A20 to A27.

The AND elements A20 to A27 supply to the respective full adders F30 to F37 the logical conjunction of the output from the AND element G12 and the value of each of the input data bits X0 to X7.

The full adder F30 supplies the carry bit to the full adder F31, as well as supplying, to the selectors S30 and S31, the addition result of adding the fixed value 0, the addition result from the full adder F21, and the output from the AND element A20. The full adder F31 supplies the carry bit to the full adder F32 as well as supplying, to the selectors S31 and S32, the addition result of adding the carry bit signal from the full adder F30, the output from the AND element A21, and the addition result from the full adder F22. The full adder F32 supplies the carry bit to the full adder F33 as well as supplying, to the selectors S32 and S33, the addition result of adding the carry bit from the full adder F31, the output from the AND element A22, and the addition results from the full adder F23. The full adder F33 supplies the carry bit to the full adder F34 as well as supplying, to the selectors S33 and S34, the addition result of adding the carry bit from the full adder F32, the output from the AND element A23, and the addition results from the full adder F24. The full adder F34 supplies the carry bit to the full adder F35 as well as supplying, to the selectors S34 and S35, the addition result of adding the carry bit from the full adder F33, the output from the AND element A24, and the addition result from the full adder F25.

The full adder F35 supplies the carry bit to the full adder F36 as well as supplying, to the selectors S35 and S36, the addition result of adding the carry bit from the full adder F34, the output from the AND element A25, and the addition result from the full adder F26. The full adder F36 supplies the carry bit to the full adder F37 as well as supplying, to the selectors S36 and S37, the addition result of adding the carry bit from the full adder F35, the output from the AND element A26, and the addition result from the full adder F27. The full adder F37 supplies, to the selector S37, the addition result of adding the carry bit from the full adder F36, the output from the AND element A27, and the addition result from the full adder F28.

While the computation mode signal MODE has a logic level of 0 indicating multiplication, the selectors S30 to S37 output 8 bits constituted of the addition results from the full adders F30, F31, F32, F33, F34, F35, F36, and F37 as the output data bits Z7 to Z0. On the other hand, while the computation mode signal MODE has a logic level of 1 indicating addition, the selectors S30 to S37 output 8 bits constituted of the addition results from the full adders F20, F30, F31, F32, F33, F34, F35, and F36 as the output data bits Z7 to Z0.

The modulation circuits 21 and 22 shown in FIG. 3 are each provided with a combination circuit 15 that combines the signal received at the additional data input terminal αDt and the signal SIN through multiplication or addition, but as long as both signals can be combined, the computation is not limited to being multiplication or addition.

As shown in FIGS. 5 to 8, in the embodiment above, the additional data signal αDD representing 4 as a decimal value is supplied, but a signal representing a prescribed fixed value other than 4 may be supplied to the additional data input terminal αDt.

Also, in the embodiment, the sine wave generation circuit 14 outputs a fixed signal SIN representing 0x04 in the state of the modulation circuit 21 shown in FIG. 5 or 7, but in that case, the signal SIN indicating another prescribed fixed value may be outputted.

Additionally, in the embodiment above, the modulation circuit 21(22) is configured to receive the modulation mode signal MOD indicating the modulation mode and the individual setting signal X1(X2) separately, but a configuration may be adopted in which setting information including information designating the modulation mode and the individual setting signal X1(X2) is received.

The modulation module 200, which generates a modulation signal generated by modulating a carrier wave on the basis of the transmission data signal, may be configured in any manner as long as the following modulation circuit is included.

Upon receiving input of first setting information including first information that designates a modulation mode, a first modulation circuit outputs a prescribed auxiliary signal as a first output signal. On the other hand, upon receiving input of second setting information including second information that designates a modulation mode, the first modulation circuit outputs a first modulation signal generated by subjecting an input signal to modulation processing based on the second setting information as the first output signal. A second modulation circuit outputs, as a second output signal, a signal generated by combining a second modulation signal generated by modulation processing with the first output signal outputted from the first modulation circuit. The first information includes a first mode signal that causes the carrier wave to undergo phase modulation or a second mode signal that causes the carrier wave to undergo frequency modulation. On the other hand, the second information includes a third mode signal that causes the carrier wave to undergo amplitude modulation or a fourth mode signal that causes the carrier wave to undergo phase/amplitude modulation.

The first modulation circuit and the second modulation circuit each include a transmission data input terminal, an additional data input terminal, an output terminal, a main processing unit, and a combination unit. The main processing unit receives the setting information including the information setting the modulation mode, and is set to any of the following first to fifth states on the basis of the setting information.

In the first state, the main processing unit outputs a signal generated by subjecting a frequency signal having the frequency of the carrier wave frequency to frequency modulation or phase modulation based on a transmission data signal. In the second state, the main processing unit outputs a signal designating the size of the amplitude on the basis of the transmission data signal. In the third state, the main processing unit outputs a frequency signal. In the fourth state, the main processing unit outputs a signal indicating a prescribed fixed value. In the fifth state, the main processing unit outputs a signal subjected to amplitude modulation and phase modulation on the basis of the transmission data signal.

The combination unit supplies, to the output terminal, a signal generated by combining a signal outputted from the main processing unit with a signal received by the additional data input terminal.

Here, the transmission data signal is received at the transmission data input terminal of the first modulation circuit, the output terminal of the first modulation circuit is connected to the additional data input terminal of the second modulation circuit, and the output terminal of the second modulation circuit outputs the modulation signal.

Thus, according to the configuration of the modulation module 200, a plurality of modulators of differing modulation modes are provided, and it is possible to have a reduced device size compared to conventional devices in which the modulator of the desired modulation mode is selected by a selector or the like.

### Embodiment 2

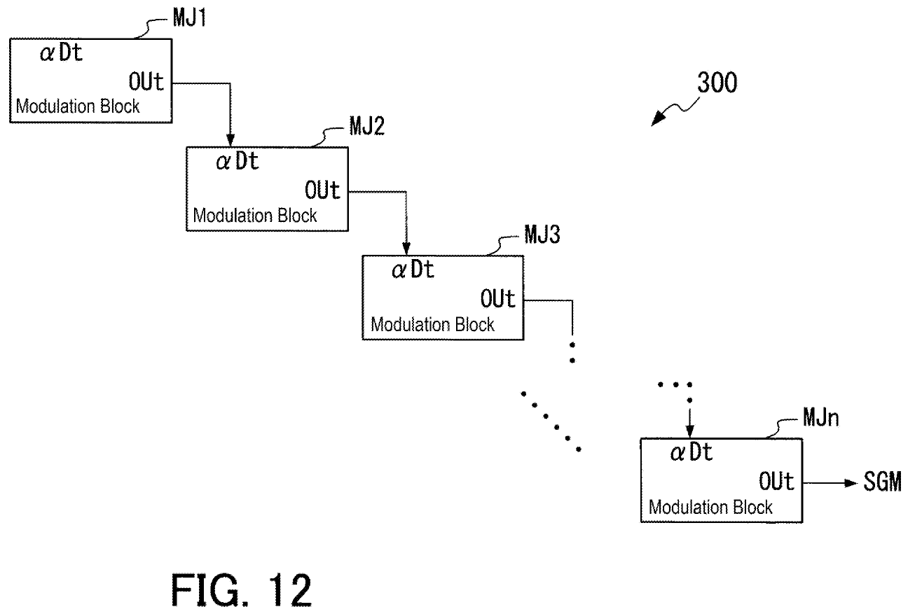

FIG. 12 is a block diagram showing the configuration of a modulation device 300 according to Embodiment 2.

The modulation device 300 shown in FIG. 12 generates a combined modulation signal SGM in which modulation signals of different modulation modes are combined.

In the modulation device 300 shown in FIG. 12, modulation blocks MJ1 to MJn (n being an integer of 2 or greater) that each include a modulation circuit having the configuration shown in FIG. 3 are in a cascade connection. The output terminal OUt of the modulation block MJ1 is connected to the additional data input terminal αDt of the modulation block MJ2, and the output terminal OUt of the modulation block MJn−1 is connected to the additional data input terminal αDt of the modulation block MJn. In other words, the output signal outputted from the modulation block MJ1 is inputted to the modulation block MJ2 as an external signal, and the output signal outputted from the modulation block MJn−1 is inputted as an external signal to the modulation block MJn. However, in the modulation device 300 shown in FIG. 12, by adopting the configuration of inputting the clock signal CLK, the reset signal REST, the modulation mode signal MOD, and the transmission data signal TXD separately to the modulation blocks MJ1 to MJn, it is possible to operate each modulation block as a modulation circuit with a different modulation mode.

If adopting the configuration shown in FIG. 12, the addition/multiplication circuit shown in FIG. 9 is adopted as the combination circuit 15 shown in FIG. 3, with this adder/multiplier circuit being used as an adder. If n is 3 or greater, the modulation block MJn−1 and the modulation block MJn can also use the adder/multiplier circuit as a multiplier.

As a result, the combined modulation signal SGM, which is the sum total of the modulation signals generated by the modulation blocks MJ1 to MJn, is outputted from the final stage modulation block MJn.

According to the modulation device 300, it is possible to simulate creation of the radio wave state from combining modulation signals outputted from a plurality of transmitters, each having different modulation modes, for example, and thus, it is possible to use the modulation device 300 as a test device that tests the radio wave state.

Also, according to the modulation device 300, a plurality of modulators of differing modulation modes are provided, and it is possible to have a reduced device size compared to devices in which modulation modules that use a selector or the like to select the modulator of the desired modulation mode are in a cascade connection.

### Embodiment 3

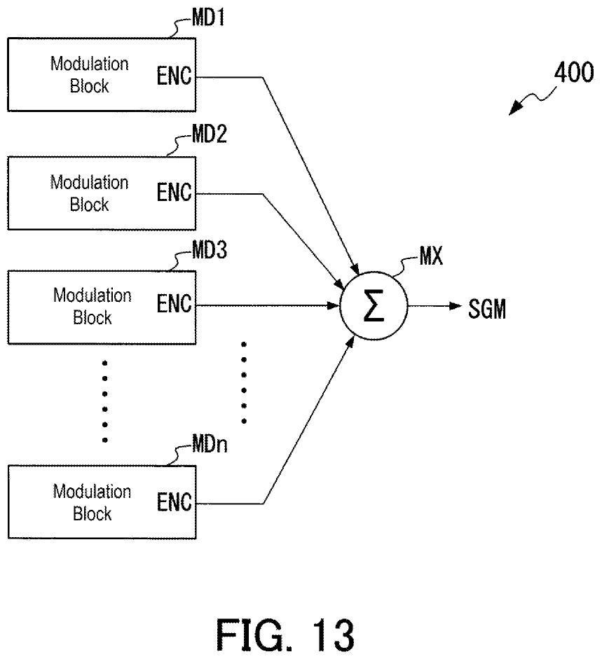

FIG. 13 is a block diagram showing the configuration of a modulation device 400 according to Embodiment 3.

The modulation device 400 shown in FIG. 13 includes modulation blocks MD1 to MDn (n being an integer of 2 or greater) that each have a similar internal configuration to the modulation module 200 shown in FIG. 1, and a total combination circuit MX.

In this case, the modulation blocks MD1 to MDn can operate as modulation circuits of different modulation modes, similar to the modulation device 300 shown in FIG. 12, as a result of the modulation mode signal MOD and the transmission data signal TXD inputted respectively thereto.

The total combination circuit MX generates a combined modulation signal SGM in which the modulation signals ENC outputted respectively from the modulation blocks MD1 to MDn are combined. The total combination circuit MX generates, as the combined modulation signal SGM, a signal that is the sum total or the average of the modulation signals ENC outputted respectively from the modulation blocks MD1 to MDn or a signal generated by performing weighted summing of the modulation signals ENC, for example.

According to the modulation device 400, similarly to Embodiment 2, it is possible to simulate creation of the radio wave state from combining modulation signals outputted from a plurality of transmitters, each having different modulation modes, for example, and thus, it is possible to use the modulation device 400 as a test device that tests the radio wave state.

Also, according to the modulation device 400, a plurality of modulators of differing modulation modes are provided, and it is possible to have a reduced device size compared to devices having modulation blocks that use a selector or the like to select the modulator of the desired modulation mode.

Additionally, according to the configuration of the modulation device 300, for example, there are limitations such as that the modulation module that performs ASK modulation is disposed at the final stage, but the configuration of the modulation device 400 allows for use without such limitations.

If, among the modulation blocks MD1 to MDn, a modulation block that can only be switched between two modulation modes including QPSK modulation and FSK modulation is included, the modulation block may include only the modulation circuit shown in FIG. 3.

What is claimed is:

1. A modulation module, comprising:
a first modulation circuit that, upon receiving input of first setting information including first information designating a modulation mode, outputs a prescribed auxiliary signal as a first output signal, but upon receiving input of second setting information including second information designating a different modulation mode from the first information, outputs a first modulation signal generated by subjecting an input signal to modulation processing based on the second setting information as the first output signal; and
a second modulation circuit that is configured to output, as a second output signal, a signal generated by combining a second modulation signal generated by modulation processing with the first output signal.

2. The modulation module according to claim 1,
wherein the first information includes a first mode signal that causes a carrier wave to undergo phase modulation or a second mode signal that causes the carrier wave to undergo frequency modulation.

3. The modulation module according to claim 1,
wherein the second information includes a third mode signal that causes a carrier wave to undergo amplitude modulation or a fourth mode signal that causes the carrier wave to undergo phase/amplitude modulation.

4. The modulation module according to claim 1,
wherein the prescribed auxiliary signal includes a fixed value.

5. The modulation module according to claim 3,
wherein the first modulation circuit
outputs the prescribed auxiliary signal, the prescribed auxiliary signal representing a prescribed fixed value, as the first output signal upon receiving input of the first setting information,
generates, as the first modulation signal, a signal generated by converting the input signal to a signal representing an amplitude upon receiving input of the second setting information including the third mode signal, and
generates, as the first modulation signal, a signal generated by subjecting the input signal to first phase/amplitude modulation processing upon receiving input of the second setting information including the fourth mode signal.

6. The modulation module according to claim 5,
wherein the second modulation circuit
outputs, as the second output signal, a result of multiplying the second modulation signal by the first output signal upon receiving input of the first setting information or the second setting information including the third mode signal,
generates, as the second modulation signal, a signal generated by subjecting the input signal to second phase/amplitude modulation processing representing a differing phase and amplitude from the first phase/amplitude modulation processing upon receiving input of the second setting information including the fourth mode signal, and outputs a result of adding the second modulation signal to the first output signal as the second output signal.

7. A modulation module, comprising:
a first combination circuit configured to output, as a first output signal, a signal generated by combining a prescribed fixed value or a first modulation signal generated by subjecting an input signal to modulation processing based on first setting information including information designating a modulation mode, with an external signal inputted from outside; and
a second combination circuit that is configured to output, as a second output signal, a signal generated by combining a second modulation signal subjected to modulation processing based on second setting information including information designating the modulation mode, with the first output signal.

8. The modulation module according to claim 7, further comprising:
a first main processing unit configured to generate the first modulation signal;
a second main processing unit configured to generate the second modulation signal;
wherein the second main processing unit
includes a third combination circuit that is configured to combine signals based on the input signal based on the second setting information.

9. The modulation module according to claim 8,
wherein the second main processing unit includes:
a data storage circuit that is configured to convert the input signal to data pieces based on the second setting information and store the data pieces, and output the stored data pieces to the third combination circuit as a data signal;
a counter that is configured to generate a frequency signal based on the second setting information and a clock signal and output the frequency signal to the third combination circuit; and
a sine wave generation circuit that is configured to output, as the second modulation signal, a sine wave signal generated by converting an output from the third combination circuit to a sine wave based on the second setting information.

10. The modulation module according to claim 9,
wherein the first main processing unit
includes a fourth combination circuit that is configured to combine signals based on the input signal based on the first setting information.

11. The modulation module according to claim 10,
wherein the first main processing unit includes:
a data storage circuit that is configured to convert the input signal to data pieces based on the first setting information and store the data pieces, and output the stored data pieces to the fourth combination circuit;
a counter that is configured to generate a frequency signal based on the first setting information and a clock signal and output the frequency signal to the fourth combination circuit; and
a sine wave generation circuit that is configured to output, as the first modulation signal, a sine wave signal generated by converting an output from the fourth combination circuit to a sine wave based on the setting information, or output the fixed value.

12. A modulation circuit, comprising:
a first combination circuit that is configured to output a signal generated by combining signals based on an input signal on a basis of setting information including information designating a modulation mode; and
a second combination circuit that is configured to combine a signal based on an output from the first combination circuit with an external signal inputted from outside and output the combined signal, based on the setting information.

13. The modulation circuit according to claim 12,
wherein the information designating the modulation mode of the setting information includes a first mode signal or a second mode signal,
wherein the first combination circuit outputs a signal resulting from adding the signals based on the input signal if the setting information includes the first mode signal and outputs a shifted signal in which a phase of a signal corresponding to a carrier wave is shifted if the setting information includes the second mode signal, and
wherein the second combination circuit outputs a signal resulting from multiplying a signal based on the signal output from the first combination circuit by the external signal.

14. The modulation circuit according to claim 13,
wherein the first mode signal is a signal prompting phase modulation, based on the input signal, of the carrier wave, and
wherein the second mode signal is a signal prompting frequency modulation, based on the input signal, of the carrier wave.

15. The modulation circuit according to claim 12, further comprising:
a data storage circuit that is configured to convert the input signal to data pieces based on the setting information and store the data pieces, and output the stored data pieces to the first combination circuit as a data signal;
a counter that is configured to generate a frequency signal based on the setting information and a clock signal and output the frequency signal to the first combination circuit; and
a sine wave generation circuit that is configured to output, to the second combination circuit, a sine wave signal generated by converting an output from the first combination circuit to a sine wave based on the setting information.

16. The modulation circuit according to claim 12,
wherein the external signal is a fixed value.

17. A modulation device, comprising:
first to nth (n being an integer of 2 or greater) modulation blocks, each of which includes the modulation circuit according to claim 12,
wherein the first to nth modulation blocks are in a cascade connection such that an output signal outputted from an n−1th modulation block among the first to nth modulation blocks is inputted as an external signal to an nth modulation block among the first to nth modulation blocks, and
wherein an output signal outputted from the nth modulation block is outputted as a combined modulation signal generated by combining modulation signals modulated by the first to nth modulation blocks, respectively.

18. The modulation device according to claim 17,
wherein, if the n is an integer of 3 or greater, the second combination circuit of each of the n−1th modulation block and the nth modulation block is an adder circuit or a multiplier circuit, and the second combination circuit of other modulation blocks is an adder circuit.

19. A modulation device, comprising:
first to nth (n being an integer of 2 or greater) modulation blocks, each of which includes the modulation module according to claim 1; and
a total combination circuit that is configured to output, as a combined modulation signal, a signal that is a sum total or an average of the second output signals outputted from the first to nth modulation blocks, or a signal generated by performing weighted summing of the second output signals.

20. A generation method for a modulation signal in a modulation device that, upon receiving input of first setting information including first information designating a modulation mode or second setting information including second information differing from the first information, generates a signal generated by subjecting an input signal to modulation processing based on the first setting information or the second setting information, the generation method comprising:
generating, as a first output signal, a prescribed auxiliary signal if the first setting information is inputted, and generating, as the first output signal, a first modulation signal generated by subjecting the input signal to the modulation processing based on the second setting information if the second setting information is inputted; and
outputting, as a second output signal, a signal generated by combining a second modulation signal generated by subjecting the input signal to modulation processing with the first output signal.

21. A generation method for a modulation signal in a modulation device that generates a modulation signal by subjecting an input signal to modulation processing based on setting information including information designating a modulation mode, the generation method comprising:
generating a first signal in which signals based on the input signal are combined, based on the setting information; and
outputting, as the modulation signal, a signal generated by combining an external signal inputted from outside with the first signal.
